(19) United States
(12) Patent Application Publication
(10) Pub. No.: US 2026/0290305 A1
(43) Pub. Date: Sep. 24, 2026

(54) SYSTEM

(71) Applicant: SoftBank Group Corp., Tokyo (JP)

(72) Inventor: Asato KUBOTA, Tokyo (JP)

(73) Assignee: SoftBank Group Corp., Tokyo (JP)

(21) Appl. No.: 19/567,354

(22) Filed: Mar. 16, 2026

(30) Foreign Application Priority Data
Mar. 19, 2025 (JP) 2025-045248

(51) Int. Cl. G10L 13/02; G06N 3/045; G10L 15/26; H04L 51/02

(52) U.S. Cl. CPC G10L 13/02; G06N 3/045; G10L 15/26; H04L 51/02

(57) ABSTRACT

A system includes a processor that is configured to acquire audio data by using an audio input means for receiving voice information from a user, analyze the acquired audio data by using natural language processing techniques, and generate a prompt for instructing a generative AI model to generate a relevant response and an additional question, and convert the generated response and the additional question into audio data for provision via an audio output means and display the generated response and the additional question.

### CROSS-REFERENCE TO RELATED APPLICATION

This application is based on and claims priority under 35 USC 119 from Japanese Patent Application No. 2025-045248 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional customer support and interactive dialog systems, voice input from a user is often converted into text and processed by predefined rules or simple dialog engines. Such systems frequently lack flexibility and contextual understanding, and they are not capable of generating rich, adaptive responses and follow-up questions in a natural manner. As a result, the quality of interaction remains limited, and it is difficult to efficiently support complex inquiries in environments such as service counters, call centers, and online consultation windows.

Furthermore, conventional systems generally do not adequately consider the emotional state of the user expressed in voice information. Even when basic sentiment detection is implemented, it is seldom integrated into a generative response process. Therefore, responses are often insensitive to the user's emotional condition, which can lead to user dissatisfaction, reduced trust, and a less effective support experience.

In addition, known systems do not sufficiently integrate generative AI models with voice input and voice output in a unified workflow. Specifically, there is a lack of systems in which voice information from the user is analyzed by natural language processing techniques, used to generate a prompt for a generative AI model, and then converted back into both displayable and audible output, while also taking account of emotion analysis. This makes it difficult to provide a seamless, multimodal interaction that can flexibly adapt to the content and emotional context of the user's utterances.

Therefore, there is a need for a system comprising a processor that can acquire voice information from the user, analyze the content using natural language processing, generate prompts to instruct a generative AI model to produce relevant responses and additional questions, and convert those results into displayable and audible formats, while also analyzing and utilizing the user's emotional state. Such a system should improve the naturalness, adaptability, and emotional appropriateness of machine-supported interactions.

### SUMMARY

In order to solve the above-described problems, an embodiment of the present invention provides a system comprising a processor, wherein the processor is configured to acquire audio data by using an audio input means for receiving voice information from a user, analyze the acquired audio data by using natural language processing techniques, and generate a prompt for instructing a generative AI model to generate a relevant response and an additional question. The processor is further configured to convert the generated response and the additional question into audio data for provision via an audio output means and to display the generated response and the additional question. By doing so, the system can realize a flexible and context-aware dialog using a generative AI model, while supporting both visual and auditory output channels.

According to another aspect of the present invention, the processor is configured to analyze an emotion of the user from the voice information and to generate the response and the additional question based on the emotion. In this manner, the system can adjust the content, tone, and structure of responses and follow-up questions in accordance with the user's emotional state, thereby improving user satisfaction and providing a more empathetic interaction.

According to still another aspect of the present invention, the processor is configured to adjust the generated response based on a result of emotion analysis and to convert the generated response into audio data by using a speech synthesis technique. As a result, the audio output provided through the audio output means can reflect not only the informational content but also an emotion-aware modulation of the response, such as a calm, considerate, or reassuring tone, depending on the emotion analysis. By integrating emotion analysis, generative AI, natural language processing, and speech synthesis in a unified system, the invention enables seamless and adaptive voice-based and display-based interactions that respond appropriately to both the content and emotional state of the user.

The term “processor” refers to one or more hardware or virtual processing units, such as a central processing unit (CPU), a microcontroller, a digital signal processor (DSP), a graphics processing unit (GPU), or a combination thereof, that executes instructions to perform the functions described in the claims.

The term “audio input means” refers to any hardware and associated software or firmware components configured to receive and digitize voice information from a user, including but not limited to microphones, microphone arrays, audio interfaces, and their drivers.

The term “audio output means” refers to any hardware and associated software or firmware components configured to output audio data in a form perceivable by a user, including but not limited to speakers, earphones, headsets, and audio amplifiers.

The term “audio data” refers to digitized representations of sound, including sampled waveforms or encoded bitstreams, that correspond to voice information spoken by a user or synthesized speech generated by the system.

The term “voice information” refers to spoken utterances or sounds produced by a user, including words, phrases, prosody, and other acoustic characteristics, that are captured by the audio input means.

The term “natural language processing techniques” refers to computational methods, algorithms, and models configured to process and analyze human language, including but not limited to speech recognition, tokenization, part-of-speech tagging, syntactic and semantic parsing, intent recognition, and entity extraction.

The term “generative AI model” refers to a machine learning model configured to generate text or other content based on input data or prompts, including but not limited to large language models, transformer-based models, and other neural network-based generative models.

The term “prompt” refers to a structured or unstructured input sequence, query, or instruction that is provided to a generative AI model to condition, guide, or constrain the generation of a response and an additional question.

The term “response” refers to output content generated, directly or indirectly, by the generative AI model, which is intended to address or answer at least part of the user's voice information or inquiry.

The term “additional question” refers to one or more follow-up inquiries generated, directly or indirectly, by the generative AI model, which are intended to obtain further information from the user or to clarify the user's needs.

The term “emotion” refers to an affective state or sentiment of the user, such as happiness, sadness, anger, frustration, neutrality, or other emotional categories, inferred from voice information or related features.

The term “emotion analysis” refers to processing by which the system estimates or classifies the user's emotional state from voice information, textual content, acoustic features, or combinations thereof.

The term “speech synthesis technique” refers to any method, algorithm, or model configured to generate audio data representing speech from text or other symbolic representations, including but not limited to text-to-speech (TTS) engines and neural speech synthesis models.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

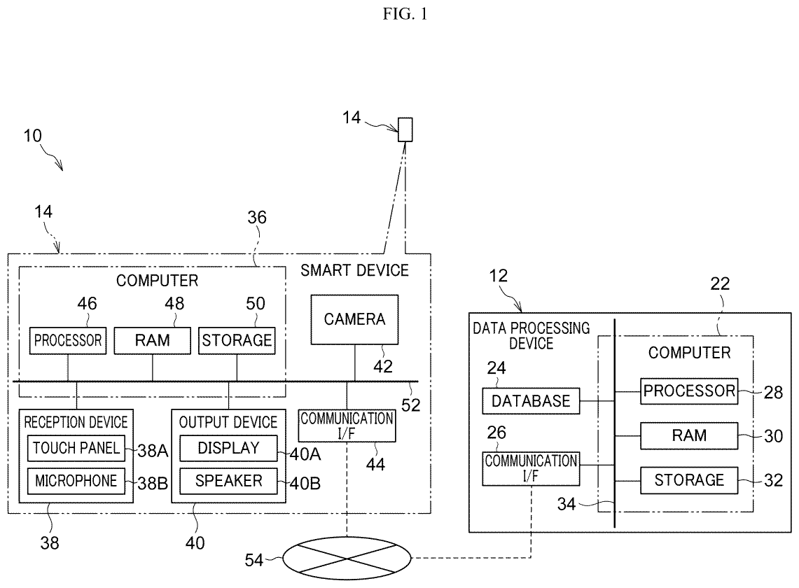

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

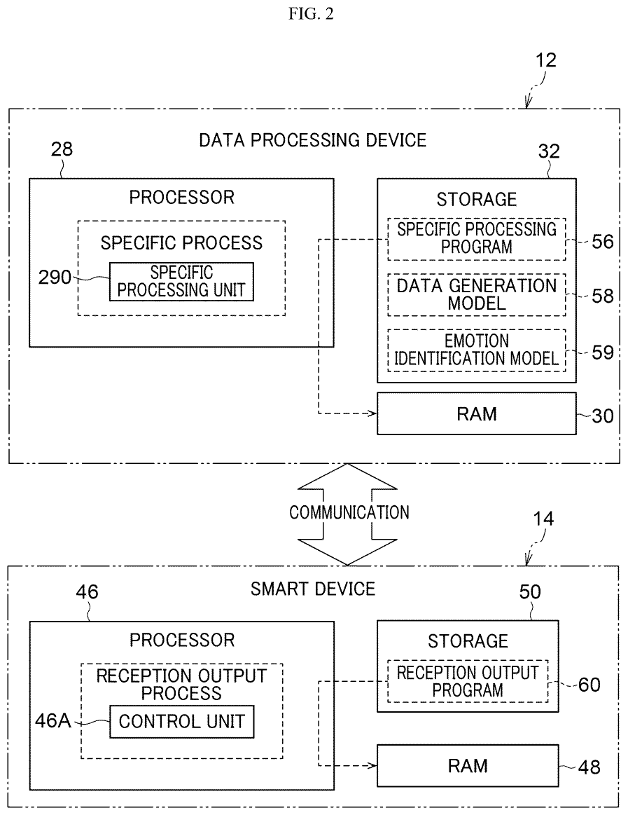

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional customer-support and in-store assistance systems that utilize speech interfaces typically perform a simple pipeline of speech recognition followed by fixed, rule-based response generation. In such systems, a processor merely converts audio input into text and matches the text against predefined scripts or dialog trees. As a result, the processor often fails to generate context-appropriate, flexible responses, and cannot scale to handle diverse, open-ended natural language queries.

Furthermore, when a generative AI model is introduced in a naive way, the processor may simply pass the recognized text to the generative AI model without any structured prompt design, intent handling, or emotion-aware adaptation. This results in unstable output quality, inconsistent level of detail, and responses that are not tailored to the actual interaction context between a staff member and a customer. In particular, the lack of systematic prompt sentence construction in accordance with question type and user intent can cause the generative AI model to produce irrelevant, overly verbose, or incomplete responses.

In addition, known systems often do not integrate the entire processing chain—audio acquisition, speech recognition, language analysis, prompt sentence generation, generative AI inference, and multimodal output control—into a unified, computer-implemented architecture that is optimized for real-time interaction. The processor in such systems lacks mechanisms to dynamically select and compose prompt templates based on question content and intent information, and to format generated responses and follow-up questions in a way that can be reliably consumed by both display devices and audio output devices. This omission leads to increased latency, unpredictable system behavior, and a higher cognitive load on human operators.

Moreover, conventional systems do not adequately leverage emotion information extracted from user utterances to control both the content of the prompts supplied to the generative AI model and the synthesis parameters used for audio output. Without consistent, machine-implemented emotion-aware control, the system cannot adapt its language tone or prosody to the emotional state of the user, which reduces the effectiveness of the interaction and can degrade user satisfaction.

Accordingly, there is a need for a computer-implemented technique that improves the operation of a processor by (i) systematically transforming audio input into structured textual and semantic representations, (ii) dynamically constructing and selecting prompt sentences for a generative AI model based on question content, intent information, and, optionally, emotion information, and (iii) producing coordinated visual and audio outputs that are suitable for real-time, human-facing support. Such a technique should enhance the reliability, consistency, and responsiveness of the overall system, thereby improving the underlying computer technology for multimodal, AI-assisted dialog processing.

The specific processing by the specific processing unit 290 of the data processing device 12 in Example 1 is realized by the following means.

The present invention provides a server comprising a processor configured to acquire audio information from a sound input apparatus and generate digital audio data; to obtain the digital audio data and convert the digital audio data into character information using a speech recognition technique; to obtain the character information and extract question content and intent information from the character information using a language analysis technique; to generate, based on the question content and the intent information, a prompt sentence to be input to a generative processing model, to provide the prompt sentence and the character information to the generative processing model, and to cause the generative processing model to generate response information and additional input question information; to select the prompt sentence from a plurality of templates according to at least one of the question content and the intent information and dynamically generate the prompt sentence by inserting the character information into a selected template; to format the response information and the additional input question information obtained from the generative processing model and output the formatted response information and the formatted additional input question information as visual information on a display apparatus; to convert the response information and the additional input question information into audio data using a speech synthesis technique and cause an audio output apparatus to output the audio data; and to transmit the response information and the additional input question information to a terminal apparatus and cause a display apparatus of the terminal apparatus to display the response information and the additional input question information. This enables the server to implement an improved, computer-centric processing pipeline that systematically transforms audio input into semantically enriched text, dynamically constructs prompt sentences for a generative AI model in accordance with question content and intent, and coherently delivers response information and follow-up question information via both visual and audio channels, thereby enhancing the reliability, consistency, and responsiveness of AI-assisted dialog processing in computer systems.

The term “audio information” refers to information representing sound, including human speech, captured by a sound input apparatus and suitable for conversion into digital audio data.

The term “sound input apparatus” refers to a hardware device configured to capture sound from an environment and output corresponding electrical or digital signals, such as a microphone or an audio capture device.

The term “digital audio data” refers to data representing sound in a digital format that can be processed by a processor, including sampled and quantized audio signals.

The term “speech recognition technique” refers to a computer-implemented technique for converting digital audio data representing speech into character information, typically using acoustic models and language models.

The term “character information” refers to data representing text obtained by converting audio information into a sequence of characters or words that can be processed by natural language processing components.

The term “language analysis technique” refers to a computer-implemented technique for processing character information to extract semantic information, including at least one of tokenization, part-of-speech tagging, parsing, intent classification, and entity extraction.

The term “question content” refers to information indicating a semantic content of a question included in the character information, such as a request type, a topic, or a target object of the question.

The term “intent information” refers to information indicating a purpose or goal expressed in the character information, such as an inquiry about warranty, price, specification, or comparison.

The term “prompt sentence” refers to text data constructed by the processor and supplied as an instruction or context to a generative processing model to control generation of response information and additional input question information.

The term “generative processing model” refers to a trained computational model that receives at least a prompt sentence and character information as input and generates natural language output, including response information and additional input question information.

The term “response information” refers to information generated by the generative processing model that represents an answer to the question content derived from the character information.

The term “additional input question information” refers to information generated by the generative processing model that represents at least one follow-up question to obtain further input from a user related to the question content.

The term “prompt template” refers to a predefined text pattern including at least one variable portion into which character information is inserted to generate a prompt sentence supplied to the generative processing model.

The term “template selection” refers to a process in which the processor selects one prompt template from a plurality of prompt templates based on at least one of the question content and the intent information.

The term “visual information” refers to information in a form suitable for presentation on a display apparatus, including formatted text, icons, or graphical elements representing response information and additional input question information.

The term “display apparatus” refers to a hardware device configured to present visual information to a user, such as a monitor, a tablet display, or a mobile device screen.

The term “speech synthesis technique” refers to a computer-implemented technique for converting text data, including response information and additional input question information, into audio data representing synthetic speech.

The term “audio output apparatus” refers to a hardware device configured to output sound based on audio data, such as a speaker or a headset.

The term “terminal apparatus” refers to an information processing device, separate from the server, configured to receive response information and additional input question information from the server and present the information to a user, typically via a display apparatus and optionally an audio output apparatus.

The term “emotion information” refers to information indicating an estimated emotional state of a user, such as satisfaction, dissatisfaction, calmness, or anger, derived from the character information using emotion analysis processing.

The term “emotion analysis processing” refers to a computer-implemented technique for analyzing character information to infer emotion information, for example by applying a trained classification model or rule-based analysis.

The term “speech synthesis parameter” refers to a control parameter used by a speech synthesis technique, including at least one of pitch, speed, volume, intonation, and speaking style, which affects how audio data is generated from text.

In one embodiment, a server cooperates with a terminal and a user to implement the claimed system. The server includes at least one processor, a memory, a non-transitory storage medium, a network interface, and interfaces for a sound input apparatus and an audio output apparatus. The terminal includes at least one processor, a memory, a display apparatus, and optionally an audio output apparatus. The user operates the terminal and positions the sound input apparatus in a real-world environment, such as a sales counter or reception desk.

The server executes an operating system, such as a general-purpose server operating system, and application software that implements a speech recognition module, a language analysis module, a prompt sentence generation module, a generative AI inference module, an emotion analysis module, a response formatting module, and an audio output control module. The server stores these modules as executable instructions on the non-transitory storage medium, such as a magnetic disk, a solid-state drive, or a flash memory device. The server loads the modules into the memory and executes them by means of the processor.

The server connects to a sound input apparatus, such as a microphone array or a networked audio capture device. The sound input apparatus converts air-pressure variations caused by human speech into analog electrical signals, and an analog-to-digital converter converts the analog electrical signals into digital audio data. The server or the terminal receives the digital audio data via a hardware interface, such as a universal serial bus interface or a network interface, and temporarily stores the digital audio data in a buffer region in the memory.

The server uses a speech recognition technique to convert the digital audio data into character information. In one embodiment, the server executes a speech recognition engine implementing a deep neural network-based acoustic model and a statistical language model.

The acoustic model may be a time-delay neural network or a recurrent neural network that receives feature vectors, such as Mel-frequency cepstral coefficients (MFCCs), computed from short-time frames of the digital audio data. The server computes MFCCs by applying a window function, a fast Fourier transform, a Mel filter bank, and a discrete cosine transform to each frame. The server then provides the MFCCs to the acoustic model, which outputs probability distributions over phonetic units. The language model receives candidate phonetic sequences and outputs the most probable word sequence by maximizing a combined likelihood of the acoustic model and the language model. The server decodes the output of the speech recognition engine to obtain character information, such as a sequence of words representing a question from a customer.

The server uses a language analysis technique to process the character information and extract question content and intent information. In one embodiment, the server executes a natural language processing library that performs tokenization, part-of-speech tagging, syntactic parsing, and semantic role labeling. The server represents the character information as a token sequence and stores the sequence in a structured data format in the memory, such as a list of token objects containing word forms, lemmas, and part-of-speech tags. The server applies an intent classification model, such as a fine-tuned transformer-based neural network, to the token sequence to obtain an intent label. The transformer-based neural network may include a plurality of self-attention layers, each of which computes attention weights over token embeddings, and a feedforward network that outputs a probability distribution over predefined intent classes, such as “warranty inquiry,” “price inquiry,” or “product comparison.” The server selects the intent label having the highest probability as the intent information.

The server further extracts question content by identifying entities, such as product identifiers or service categories, from the character information. The server may use a named entity recognition model that assigns an entity type to each token, and groups consecutive tokens sharing an entity type to form entity spans. The server stores the question content and the intent information in a structured record in the memory, for example as key-value pairs in a data structure.

The server uses a prompt sentence generation module to generate a prompt sentence to be supplied to a generative AI model. The server stores a plurality of prompt templates in the non-transitory storage medium. Each prompt template is a text pattern including a variable part that is replaced by the character information or a portion of the character information. For example, the server may store a template:

“Analyze the following customer question and generate a concise answer suitable for a store clerk to say to the customer. Also generate one follow-up question to clarify the customer's needs. Customer question: ‘{question_text}’”

The server selects one of the prompt templates based on the intent information. The server may implement a rule table that maps intent labels to template identifiers. For example, when the intent information indicates a “warranty inquiry,” the server selects a template specialized for warranty-related questions. When the intent information indicates a “product comparison,” the server selects another template, such as:

“Using the following customer question, generate an answer that compares the relevant products in simple terms that a store clerk can explain. Also generate one follow-up question that helps identify which product is more suitable for the customer. Customer question: ‘{question_text}’”

The server replaces the variable portion “{question_text}” with the character information, or a normalized version of the character information, thereby generating a concrete prompt sentence. The server stores the prompt sentence in the memory and logs the prompt sentence for traceability.

The server uses a generative AI model to generate response information and additional input question information based on the prompt sentence and the character information. In one embodiment, the server executes a large-scale language model implemented as a transformer-based neural network with multiple encoder-decoder or decoder-only layers. The generative AI model is stored in the non-transitory storage medium as a set of weight parameters and a model definition. The server loads the generative AI model into a processing unit optimized for matrix computation, such as a graphics processing unit (GPU) or a tensor processing unit.

The server represents the prompt sentence and the character information as token sequences using a tokenizer. The tokenizer maps each word or subword unit to an integer identifier. The server arranges the token sequences into an input tensor and supplies the input tensor to the generative AI model. Each layer of the generative AI model computes intermediate representations by performing linear transformations, self-attention computations, and non-linear activations. The self-attention layers compute attention scores between all pairs of tokens, allowing the model to capture long-range dependencies. The server applies the layers sequentially and obtains an output distribution over a vocabulary at each time step.

The server uses a decoding algorithm, such as greedy decoding or beam search, to select the most probable next token at each step and generate an output token sequence representing the response information and the additional input question information. The server may instruct the generative AI model to separate the response information and the additional input question information using a special delimiter phrase, such as “Follow-up question:”. The server then splits the output token sequence into two text segments, one segment for the response information and another segment for the additional input question information.

The server implements an emotion analysis module to extract emotion information from the character information. The server may apply a neural network classifier that receives sentence embeddings as input and outputs probabilities for emotion categories, such as “neutral,” “positive,” or “negative.” The server obtains the sentence embeddings from a pre-trained text encoder, such as a transformer-based network that maps the token sequence to a fixed-length vector. The server uses a loss function, such as cross-entropy, during training of the emotion analysis model, and updates model parameters using a gradient-based optimization algorithm, such as stochastic gradient descent or Adam. During inference, the server selects the emotion category having the highest probability as the emotion information.

The server uses the emotion information to adjust the content of the prompt sentence. For example, when the emotion information indicates dissatisfaction, the server may select a template including an instruction to generate an apologetic and reassuring tone, such as: “Analyze the following customer question from a dissatisfied customer and generate a polite and empathetic answer that acknowledges the concern. Also generate one follow-up question to better understand the problem. Customer question: ‘{question_text}’”

The server thus modifies the prompt sentence so that the generative AI model produces responses tailored to the emotional state of the customer. This interaction between the emotion analysis module and the prompt sentence generation module results in consistent, machine-controlled adaptation of language style, which is not achievable by simple rule-based substitution alone.

The server formats the response information and the additional input question information for visual presentation. The server constructs a data structure comprising fields for text content, display priority, and formatting attributes, such as bold emphasis or font size. The server transmits the formatted data structure to the terminal via the network interface using a communication protocol, such as hypertext transfer protocol secure (HTTPS) or a persistent bidirectional protocol. The terminal receives the data structure, parses the fields, and renders the response information and the additional input question information on the display apparatus. The terminal may display the response information in a larger font at the top of the screen and the additional input question information beneath it, in order to reduce the cognitive load on the user.

The server also converts the response information and the additional input question information into audio data using a speech synthesis technique. In one embodiment, the server uses a neural speech synthesizer, such as a sequence-to-sequence model with an attention mechanism, that converts text sequences into spectrogram representations, followed by a neural vocoder that converts the spectrograms into time-domain waveforms. The server adjusts speech synthesis parameters, such as pitch, speed, and intonation, based on the emotion information. For example, when the emotion information indicates urgency, the server may increase speech speed and adjust pitch contours to convey urgency. The server sends the audio data to the audio output apparatus, which reproduces the audio as sound in the physical environment.

The user observes the display apparatus of the terminal and hears the audio output from the audio output apparatus. The user can use the response information and the additional input question information to interact with a customer or another person in the real world. Because the server controls the entire processing pipeline from acoustic input to multimodal output, the system reduces manual effort in constructing replies, improves response consistency, and lowers latency in delivering information.

The server provides technical improvements over conventional systems by using specific algorithmic structures and data flows. The server reduces processing latency by pre-loading the generative AI model parameters into a GPU memory and by using optimized batch processing for speech recognition and language analysis. The server improves response accuracy by explicitly structuring the input to the generative AI model as a prompt sentence that incorporates question content, intent information, and emotion information. This structured prompting reduces ambiguity in the input, leading to lower error rates in generated responses.

The server reduces communication load between the server and the terminal by transmitting compact, structured data representing the response information and the additional input question information, instead of raw audio streams, and by performing high-cost inference operations centrally on the server. The server further improves data management by representing each interaction as a record containing audio identifiers, recognized text, intent information, emotion information, selected template identifiers, generated prompt sentences, and generated responses. The server can index and retrieve these records for later analysis or model improvement.

The server improves computer technology by defining a non-conventional sequence of operations and data structures that are specifically adapted to generative AI models. In particular, the server does not merely automate a human conversation pattern. Instead, the server enforces a machine-oriented design where question content, intent information, and emotion information are explicitly separated, encoded, and combined into prompt sentences. This separation enables modular optimization of each component: the speech recognition engine, the intent classifier, the emotion analysis module, and the generative AI model. The server can independently update or retrain each module, using supervised learning with labeled data and an appropriate loss function, to reduce classification errors and generation errors.

The server may implement alternative embodiments of the generative AI model. In one alternative, the server uses an encoder-decoder architecture that encodes the prompt sentence into a latent representation and decodes the representation into a response sequence. In another alternative, the server uses a decoder-only architecture that treats the prompt sentence and the expected response as a single contiguous sequence and learns to predict subsequent tokens conditioned on previous tokens. In both cases, the server stores model weights as multi-dimensional tensors and updates the weights during training by computing gradients of a loss function, such as cross-entropy between predicted token distributions and ground-truth tokens, and applying gradient descent or its variants.

The server may implement variations in the prompt sentence generation logic. For example, the server may compute a confidence score for the intent information and choose a more generic template when the confidence is below a threshold. The server may insert additional context, such as historical interactions or product metadata, into the prompt sentence when available. The server may also incorporate explicit constraints into the prompt sentence, such as “Use no more than three sentences” or “Explain in simple terms for a non-expert,” to control output length and complexity.

The server may implement variations in the emotion analysis and speech synthesis integration. For example, the server may map emotion categories to numerical control vectors that influence both text style selection (e.g., formal vs. casual phrasing) and prosodic parameters in the speech synthesizer. The server may adjust noise injection levels, sampling temperature, or beam search parameters in the generative AI model according to the emotion information to balance creativity and determinism.

The terminal may be implemented as a general-purpose computing device, such as a desktop computer, a tablet, or a handheld device. The terminal executes a client application that handles user authentication, communication with the server, and rendering of the response information and the additional input question information. The terminal may also implement local caching of recent responses to minimize network traffic and further reduce latency.

The user can deploy the system in various environments, including retail stores, call centers, information kiosks, or remote support settings. In each environment, the system interacts with real-world hardware devices, such as microphones, speakers, and displays, and processes physical signals, such as live audio input. The server thereby performs more than an abstract manipulation of text: it directly controls and coordinates physical devices through specific, non-conventional processing sequences to achieve improved accuracy, speed, and reliability in real-time conversational assistance.

Through these configurations, the server implements a concrete improvement in computer-implemented dialog processing technology. The combination of structured prompt sentence generation based on question content, intent information, and emotion information; the use of specific neural network architectures and training methods; and the integration with audio and display hardware produces technical effects such as reduced recognition and generation errors, decreased response time, improved resource utilization, and enhanced robustness of the system under variable input conditions.

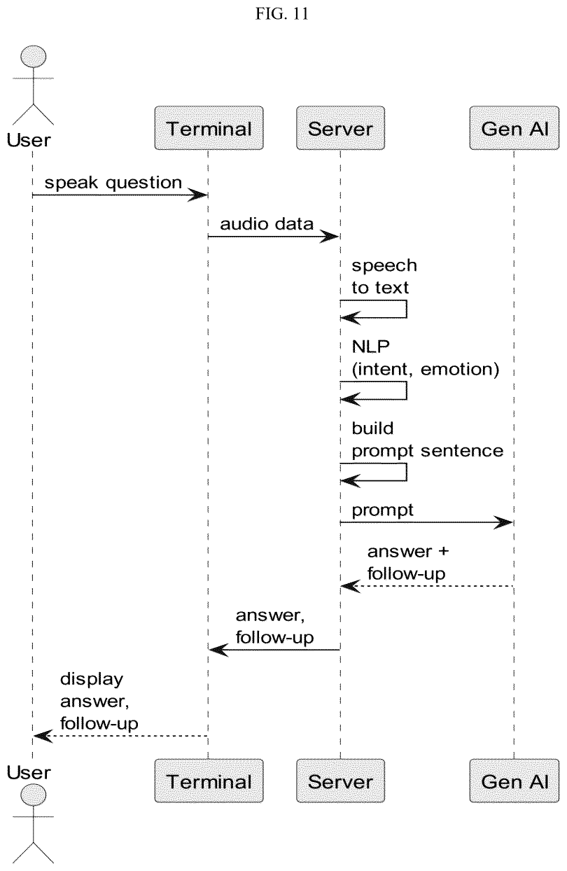

The following describes the processing flow using FIG. 11.

### Step 1:

The user positions a sound input apparatus, such as a microphone, near a customer and starts a client application on the terminal. The input of this step is acoustic sound waves produced by the customer's speech. The terminal converts the acoustic sound waves into analog electrical signals via the microphone and then into digital audio data via an analog-to-digital converter. The terminal writes the resulting digital audio samples, for example 16-bit PCM samples at 16 kHz, into an audio buffer in memory. The output of this step is buffered digital audio data representing the spoken question, such as “How long is the warranty period for this product?”.

### Step 2:

The terminal transmits the buffered digital audio data to the server. The input of this step is the digital audio data stored in the terminal's audio buffer. The terminal encapsulates the audio data in a network message, for example an HTTPS POST request body, and adds metadata such as sampling rate and encoding format. The terminal sends the request to a predefined API endpoint exposed by the server. The output of this step is a network packet stream carrying the digital audio data from the terminal to the server.

### Step 3:

The server receives the network packet stream and reconstructs the digital audio data. The input of this step is the incoming network data from the terminal. The server's communication module reassembles TCP segments, verifies integrity using checksums, and extracts the payload that contains the audio samples. The server stores the extracted digital audio data in a memory buffer associated with a new interaction session identifier. The output of this step is session-indexed digital audio data ready for speech recognition processing.

### Step 4:

The server performs speech recognition on the digital audio data and generates character information. The input of this step is the digital audio data and sampling parameters. The server segments the audio into short frames, applies a window function, and computes Mel-frequency cepstral coefficients (MFCCs) for each frame. The server feeds the MFCC feature vectors into a trained acoustic model, such as a deep neural network, that outputs probability distributions over phonetic units. The server combines the acoustic model output with a language model, such as an n-gram model or a transformer-based model, and runs a decoding algorithm (for example, Viterbi search or beam search) to obtain the most probable word sequence. The output of this step is character information, for example the text string “How long is the warranty period for this product?”.

### Step 5:

The server performs language analysis on the character information to extract question content and intent information. The input of this step is the text string produced by speech recognition. The server tokenizes the text into words or subwords, assigns part-of-speech tags using a syntactic tagger, and identifies entities such as product references using a named entity recognition model. The server then applies an intent classification model, for example a transformer-based classifier, that receives the token embeddings and outputs a probability distribution over predefined intent categories. The server selects the category with the highest probability as the intent information, such as “warranty inquiry,” and records entities like “this product” as question content. The output of this step is a structured representation containing the original text, the question content, and the intent information.

### Step 6:

The server optionally performs emotion analysis on the character information to derive emotion information. The input of this step is the tokenized text and possibly sentence-level embeddings. The server feeds the embeddings into a trained emotion classifier, such as a neural network with fully connected layers, which outputs probability scores for emotion labels, for example “neutral,” “frustrated,” or “satisfied.” The server selects the label with the highest score as the emotion information and associates it with the current interaction session. The output of this step is emotion information indicating the estimated emotional state of the customer.

### Step 7:

The server selects a prompt template and generates a concrete prompt sentence for a generative AI model. The input of this step is the structured representation including question content, intent information, and optionally emotion information. The server consults a template mapping table that associates each intent category, and optionally each emotion category, with one or more prompt templates. For a “warranty inquiry,” the server may select a template such as:
“Analyze the following customer question and generate a concise answer suitable for a store clerk to say to the customer. Also generate one follow-up question to clarify the customer's needs. Customer question: ‘{question_text}’”
The server replaces “{question_text}” with the recognized text “How long is the warranty period for this product?”, and, if emotion information indicates dissatisfaction, the server may select an alternative template such as:
“Analyze the following customer question from a dissatisfied customer and generate a polite and empathetic answer that acknowledges the concern. Also generate one follow-up question to better understand the problem. Customer question: ‘How long is the warranty period for this product?’”
The server concatenates fixed and variable parts into a complete prompt string. The output of this step is a concrete prompt sentence stored in memory.

### Step 8:

The server invokes a generative AI model using the prompt sentence and the character information as inputs and generates response information and additional input question information. The input of this step is the prompt sentence (and optionally the original question text). The server tokenizes the prompt sentence using a vocabulary defined for the generative AI model and converts tokens into embeddings. The server supplies the embeddings to a transformer-based neural network that iteratively computes hidden states via self-attention layers and feedforward layers. The server runs an autoregressive decoding algorithm, predicting one token at a time and updating hidden states until an end-of-sequence token is produced. The generated token sequence corresponds to output text, for example:
“Answer: The warranty period for this product is one year.
Follow-up question: Would you like to know about extended warranty options as well?”
The server splits the output text at known delimiters (“Answer:” and “Follow-up question:”) to separate response information from additional input question information. The output of this step is a pair of text strings representing the response information and the additional input question information.

### Step 9:

The server formats the response information and the additional input question information for visual presentation and for transmission to the terminal. The input of this step is the pair of text strings generated in Step 8. The server constructs a structured message including fields such as “answer_text,” “follow_up_text,” and optional formatting hints like “priority” or “highlight.” The server serializes this structured message into a response payload, for example a JSON or similar structured format, and attaches a session identifier. The server then sends the payload to the terminal through the network interface using a communication protocol such as HTTPS. The output of this step is a network response carrying the formatted response information and additional input question information.

### Step 10:

The terminal receives the network response and displays the response information and the additional input question information on the display apparatus. The input of this step is the structured payload received from the server. The terminal's client application parses the payload, retrieves the “answer_text” and “follow_up_text” fields, and maps optional formatting hints to user interface elements. The terminal renders the answer text in a prominent position on the display, for example at the top of the screen in a larger font, and displays the follow-up question beneath it. The output of this step is a visual presentation that the user can read directly, such as:
“Answer: The warranty period for this product is one year.
Follow-up question: Would you like to know about extended warranty options as well?”

### Step 11:

The server converts the response information and the additional input question information into audio data and outputs the audio through an audio output apparatus. The input of this step is the same pair of text strings used in Step 9, optionally augmented by emotion information. The server provides the text and control parameters (pitch, speed, tone) to a neural speech synthesis engine, which converts the text into intermediate acoustic features, such as spectrogram frames, using an encoder-decoder network with attention. The server forwards the acoustic features to a vocoder network that generates time-domain waveform samples. The server streams the waveform samples to an audio output interface connected to speakers. The output of this step is synthesized speech audible to the user and customer, reproducing the response information and additional input question information.

### Step 12:

The user observes the information on the terminal and conducts an interaction with the customer based on the displayed and/or spoken content. The input of this step is the visual and audio output provided by the terminal and the audio output apparatus. The user reads the answer text, optionally listens to the synthesized audio, and then relays or rephrases the answer to the customer. The user may also decide whether to pose the follow-up question displayed on the terminal, for example, “Would you like to know about extended warranty options as well?”. The output of this step is a real-world conversational response delivered by the user to the customer, which can in turn generate new spoken questions that re-enter the system at Step 1.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional computer-implemented customer support systems utilizing speech interfaces and language generation, the overall processing pipeline from user speech input to generated response display is often implemented as a loosely coupled aggregation of independent services. Audio capture, speech recognition, prompt construction, language generation, and user interface display are typically orchestrated by application-specific logic without a unified control structure in the processor. As a result, several technical problems arise in terms of computer technology itself.

First, the processor frequently exchanges unstructured or semi-structured data among multiple external services, such as speech recognition resources and generative language resources, without enforcing a stable, machine-verifiable data format at intermediary stages. This causes increased parsing overhead, error handling complexity, and failure rates when the output of a speech recognition resource or a generative language resource deviates from the expected format. The processor must perform ad hoc string manipulation and repeated re-tries, which leads to increased CPU utilization, longer latency, and decreased throughput at scale.

Second, the construction of input instruction text (prompt sentences) for a generative information processing model is often performed using static or hard-coded strings that do not adapt in a structured manner to the recognized text content or to operational constraints. Because the processor does not employ a template-based prompt selection mechanism with explicit insertion of recognized character information and constraint information, the resulting prompts tend to be inconsistent and difficult to manage programmatically. This lack of systematic prompt control degrades the reliability and predictability of the generative model output, and prevents efficient reuse and optimization of prompt patterns in the execution environment.

Third, when a generative information processing model outputs response information and additional guidance information, the processor frequently receives such information in a free-text form that does not conform to a predetermined structured format (for example, a machine-readable key-value structure). In the absence of a dedicated response generation unit configured to check and normalize the structure of generated data, downstream modules, such as information providing units and display control units, must implement redundant and error-prone parsing logic. This increases the complexity of the software modules executed by the processor, impairs maintainability, and can cause failures in the transformation of generated content into display-ready data for terminal devices.

Fourth, many existing systems treat the terminal device merely as a passive display endpoint without a clear division of responsibilities between server-side processing and client-side display control. Because the processor on the server side does not explicitly define a flow in which structured information is transmitted to the terminal device and converted there into display information under a unified control concept, the system cannot take full advantage of structured data transmission. This limitation leads to inefficient data transfer, ambiguous UI behavior, and difficulty in updating display logic independently of back-end processing logic. Accordingly, there is a need for an improved computer-implemented system and server-side processing mechanism in which a processor centrally controls (i) the acquisition and digitization of user audio, (ii) the conversion of audio into character information by an external speech recognition resource, (iii) the construction of template-based generation processing instruction sentences (prompt sentences) by a natural language processing unit, (iv) the normalization of outputs from an external generative information processing model into a predetermined structured format by a response generation unit, and (v) the transmission of structured information to a terminal device for controlled visual presentation. By addressing these issues at the level of the processing architecture and data structures, the invention aims to improve the reliability, efficiency, and scalability of computer systems that integrate speech recognition and generative language models.

The specific processing by the specific processing unit 290 of the data processing device 12 in Application Example 1 is realized by the following means.

The present invention provides a server comprising a processor configured to receive, as input data, voice information acquired from a user and convert the voice information into a digital signal by using an audio information acquisition unit; convert the digital audio signal into character information by using an external information processing resource having a speech recognition function; construct, on the basis of the character information, a generation processing instruction sentence by using a natural language processing unit that selects at least one template from among a plurality of templates and inserts the character information and constraint information into the selected template; input the generation processing instruction sentence into an external generative information processing model; format response sentence information and additional input guidance sentence information acquired from the generative information processing model by using a response generation unit that determines whether the acquired information conforms to a predetermined structured format and, when the acquired information does not conform to the predetermined structured format, reorders or supplements the acquired information so as to conform to the predetermined structured format; and transmit, by an information providing unit, the formatted response sentence information and additional input guidance sentence information as structured information to a terminal device so that the terminal device converts the structured information into display information capable of being visually presented to the user. This enables a computer system in which speech recognition resources and generative information processing models are integrated to process user voice input into display-ready response information with reduced parsing errors, improved structural consistency of data exchanged between components, and enhanced efficiency and reliability in server-side orchestration and client-side presentation.

The term “processor” refers to a computing element, such as a central processing unit or a computing core, that executes program instructions to perform data acquisition, analysis, transformation, and communication operations defined by software.

The term “voice information” refers to information representing sound produced by a user, including spoken utterances, captured as an analog or digital audio signal suitable for processing by an audio input device.

The term “audio information acquisition unit” refers to a functional component, implemented by hardware and/or software, that captures user voice information from an audio input device and converts the captured sound into a digital audio signal in a time domain or a frequency domain.

The term “digital audio signal” refers to audio data represented as discrete numerical values obtained by sampling an analog sound signal over time and optionally transforming the sampled values into a frequency-domain representation.

The term “external information processing resource having a speech recognition function” refers to a computational resource, such as a remote or local software service, that receives digital audio data and outputs character information corresponding to recognized speech content.

The term “character information” refers to a sequence of symbols, such as letters, numerals, or other textual characters, representing the content of recognized speech in a machine-readable text format.

The term “natural language processing unit” refers to a functional component, implemented by software executed by the processor, that analyzes and manipulates character information using natural language processing techniques to generate or modify text, including instruction sentences.

The term “generation processing instruction sentence” refers to a text string used as a prompt sentence that instructs a generative information processing model how to generate response information, including constraints, context, and formatting requirements.

The term “template” refers to a predefined text pattern containing fixed portions and insertion positions into which character information and constraint information are placed to construct a generation processing instruction sentence.

The term “constraint information” refers to supplementary information, such as response style condition information or business condition information, that specifies limitations, conditions, or desired characteristics applied to the generation of response information by a generative information processing model.

The term “generative information processing model” refers to a machine-learned model, such as a generative AI model, that receives a generation processing instruction sentence as input and outputs generated text, including response sentence information and additional guidance information, based on probabilistic or learned representations.

The term “response sentence information” refers to generated text that presents an answer, explanation, or other direct response to a user's inquiry or recognized text content.

The term “additional input guidance sentence information” refers to generated text that prompts, guides, or encourages a user to provide further input, such as a follow-up question or clarification, in connection with a prior inquiry.

The term “response generation unit” refers to a functional component, implemented by software executed by the processor, that receives output from a generative information processing model, determines whether the output conforms to a predetermined structured format, and performs formatting, reordering, or supplementation of the output.

The term “predetermined structured format” refers to a defined data structure specification, such as a key-value format, list format, or hierarchical format, that prescribes the arrangement and labeling of elements within generated information for machine processing.

The term “structured information” refers to information organized according to the predetermined structured format so that it can be reliably parsed, transmitted, and processed by software components.

The term “information providing unit” refers to a functional component, implemented by software executed by the processor, that transmits structured information, including response sentence information and additional input guidance sentence information, from the server to a terminal device.

The term “terminal device” refers to an electronic device, such as a portable computing device or stationary display device, that receives structured information from a server and outputs visual or other user-perceptible content based on the received information.

The term “display information” refers to data derived from structured information that is formatted for presentation on a user interface of a terminal device, such as rendered text, icons, or graphical elements.

The term “display control unit” refers to a functional component implemented on the terminal device that controls rendering of display information on a screen or other output interface for viewing by a user.

In one embodiment, a server cooperates with one or more terminals to implement a system that acquires user speech, converts the speech to text, constructs a structured prompt sentence for a generative AI model, normalizes the generated response into a predetermined structured format, and provides the normalized information to the terminal for visual presentation. The server executes software modules on one or more processors, and the terminal executes a user interface application on a processor of a client device such as a smartphone, tablet, or dedicated display device.

The server uses commodity hardware such as a multi-core central processing unit, volatile and non-volatile memory, and network interfaces for wired or wireless communication. The server runs an operating system such as a general-purpose server operating system, and a web application framework such as a typical HTTP application framework to expose application programming interfaces. The terminal uses a built-in microphone, a display panel such as a liquid crystal display or an organic light emitting display, and a wireless communication module such as a wireless local area network interface or a cellular communication interface. The terminal runs a client operating system such as a mobile device operating system and executes a native or hybrid application implemented in a general-purpose programming language.

The server stores program modules corresponding to an audio information acquisition unit, a natural language processing unit, a response generation unit, and an information providing unit. The server configures these modules to handle specific data structures and to perform defined data transformations. The server represents audio information as sampled multi-byte integer arrays, text information as Unicode character sequences, and structured information as key-value mappings or nested list structures.

The server causes the audio information acquisition unit to receive audio data from the terminal. The terminal captures the user's speech using the microphone and operating system audio APIs, for example a typical recording API on a mobile operating system, and transmits the digitized waveform to the server as a byte stream encoded with linear pulse code modulation at a predetermined sampling frequency and bit depth. The server optionally converts the sampling rate or encoding format using an audio processing library such as a common multimedia processing library, and stores the resulting digital audio signal in memory or temporary storage.

The server then causes the natural language processing unit to invoke an external information processing resource having a speech recognition function. In one embodiment, the server uses a cloud-based speech recognition service, such as a general cloud speech-to-text service, by transmitting the linear pulse code modulation data along with configuration parameters such as language code, acoustic model selection, and punctuation options. The external resource computes acoustic features such as Mel-frequency cepstral coefficients and applies a deep neural network model, which may be a recurrent or transformer-based acoustic model combined with a language model, to decode the most likely token sequence representing the spoken utterance. The server receives, as character information, a text string corresponding to the recognized speech, for example:
“How long is the warranty period for this product?”

The server stores this character information as a sequence of Unicode code points in a text buffer and associates it with a session identifier. The server can additionally store confidence scores and timing information in a structured data record to enable downstream evaluation and logging.

The server then causes the natural language processing unit to construct a generation processing instruction sentence, which functions as a prompt sentence to a generative AI model. The server maintains multiple prompt templates in a template repository. Each template is a structured text pattern containing fixed instruction portions and placeholders for inserting recognized text and constraint information. For example, one template may be:
“You are an in-store customer service assistant. Read the customer's question and generate an accurate and concise answer.\n\nCustomer's question: \“{question}\”\n\nAnswer:”

Another template may instruct the model to produce both an answer and a follow-up question:
“You are a customer support assistant for a retail environment. Based on the customer's question, generate (1) a clear, polite answer and (2) an appropriate follow-up question to better understand the customer's needs.\n\nCustomer's question: \“{question}\”\n\nAnswer and follow-up question:”

The server causes the natural language processing unit to select a template according to the content of the character information and to operational conditions. For example, the server can apply rule-based logic or a lightweight classifier to decide whether a follow-up question is required, based on the presence of interrogative terms, domain tags, or conversation context stored in the session state. The server then inserts the recognized question into the placeholder {question} and may insert response style condition information, such as “respond in polite language” or “limit the response to two sentences,” into additional placeholders. As a result, the server constructs a concrete prompt sentence, for example:
“You are an in-store customer service assistant. Read the customer's question and generate an accurate and concise answer.\n\nCustomer's question: \“How long is the warranty period for this product?\”\n\nAnswer:”

The server then provides this generation processing instruction sentence to an external generative information processing model. In one embodiment, the server uses a transformer-based generative AI model provided by a cloud service. The generative AI model is a large-scale neural network that applies self-attention mechanisms across token sequences. The model has multiple encoder-decoder or decoder-only layers, each comprising multi-head attention sublayers, feed-forward sublayers, and normalization sublayers.

The server tokenizes the prompt sentence into subword units by using a predetermined tokenizer such as a byte pair encoding or sentence piece model, and transmits the resulting token sequence to the model along with parameters such as maximum output length, temperature, and sampling strategy. Internally, the model embeds tokens into high-dimensional vectors, propagates them through stacked transformer blocks, and computes probability distributions for the next tokens at each step. The model has been trained by minimizing a cross-entropy loss function between predicted tokens and ground-truth tokens on large-scale text corpora, using gradient-based optimization such as stochastic gradient descent or an adaptive variant. The model applies weight updates according to backpropagation algorithms during training, and the resulting parameters are fixed during inference. This concrete architecture and learning procedure enables the model to map instruction sentences and question text to plausible answer and follow-up text sequences under constrained decoding strategies.

The server obtains from the generative AI model a candidate output sequence representing response sentence information and, in some embodiments, additional input guidance sentence information. For example, the output may consist of:
“The warranty period for this product is one year.”
or, when using a template requesting both answer and follow-up question:
“The warranty period for this product is one year. Would you like to know what is covered under this warranty?”

The server then causes the response generation unit to normalize the model output into a predetermined structured format. The server defines the structured format as, for example, a key-value mapping with keys “answer” and “follow_up_question”. To achieve normalization, the server uses a nontrivial algorithm that reduces parsing ambiguity and improves robustness. In one embodiment, the server constrains the model by embedding explicit delimiters in the prompt, such as:
“You are a customer support assistant. Output the result in the following format:\nAnswer: [answer text]\nFollow-up: [follow-up question]\n\nCustomer's question: \“How long is the warranty period for this product?\”\n\nAnswer and follow-up:”

However, the model may still deviate from the desired pattern. Therefore, the server causes the response generation unit to evaluate the returned text using deterministic parsing rules, such as regular expression patterns and token-level segmentation, and to check whether at least the “Answer:” and “Follow-up:” markers appear in the expected order. When the returned text does not satisfy the structural constraints, the server triggers corrective procedures, such as:
re-parsing the text with tolerant regular expressions that accept minor variations;
splitting the text based on sentence boundaries and assigning the first sentence to the answer field and remaining sentences to the follow-up field;
or, in some embodiments, issuing a secondary normalization request to a smaller, locally hosted model with a prompt that instructs deterministic restructuring.

By enforcing this structured format and by performing these normalization steps, the server reduces the burden on downstream components and ensures that the terminal receives data in a predictable key-value form. This deterministic response generation unit is not merely a pass-through; it applies specific reordering and completion rules to transform free-form model output into structured information, thereby improving the reliability and technical behavior of the system.

The server then causes the information providing unit to transmit the structured information to the terminal. The server packages the normalized answer and follow-up fields into a structured object and sends it through an application-layer protocol over a secure channel. Because the information is already validated and normalized, the server reduces the need for repeated client-side error handling and avoids re-transmission cycles that would occur if malformed data were sent.

The terminal receives the structured information and causes a display control unit to convert the structured information into display information. The terminal maps the “answer” field to a primary text region and the “follow_up_question” field to a secondary text region or interactive element, such as a button suggesting additional clarification. The terminal uses its rendering engine, for example a native UI toolkit, to paint the text with specified fonts, sizes, and layouts. The terminal can also store a local copy of recent structured information in a buffer to enable rapid re-display without additional network communication.

The user views the rendered response on the display and responds to the customer. The user may optionally select the follow-up question displayed by the terminal, which can trigger a new round of speech capture and processing. This closed-loop human-computer interaction uses the server's structured data pipeline to maintain coherence across multiple conversational turns.

This configuration produces several technical effects beyond mere automation of human reasoning. The server's use of template-based prompt construction and explicit constraint fields improves the predictability of generative AI model outputs, thereby reducing variance and misinterpretation in the response content. The response generation unit's structured normalization reduces parsing failures and obviates ad hoc, high-overhead text processing in downstream modules, which in turn reduces processor cycles and memory allocation overhead per request. The server's enforcement of a predetermined structured format allows simpler, constant-time lookups at the terminal side, minimizing JSON-like traversal or heuristic parsing that previously consumed computational resources. These technical improvements translate into lower end-to-end latency, higher throughput for concurrent requests, and a decreased rate of malformed responses that would require reprocessing.

Moreover, the architecture improves data management and communication efficiency. Because the server transmits compact structured fields rather than raw, unstructured passages, the system can selectively omit nonessential tokens, compress payload sizes, and cache partial results. For example, the server can cache answer text for frequently asked questions identified by hash keys derived from the normalized question text. When a similar question is recognized by the speech recognition resource, the server can reuse cached structured information instead of invoking the generative AI model again, thereby reducing computational load, network bandwidth usage, and energy consumption.

The server uses the generative AI model in combination with deterministic control logic to implement non-conventional processing steps. Unlike a human operator, who might improvise a response without structural constraints, the server enforces machine-oriented rules on the generative output, including mandatory field separation and adherence to a predefined schema. This hybrid of probabilistic generation and rule-based normalization results in a processing pipeline that is specifically adapted to the constraints of computer systems, such as strict typing and structured messaging. The causality is as follows: the template selection and structured prompt sentence formation reduce ambiguity at the model input; the transformer-based architecture and learned parameters provide expressive yet constrained sequence prediction; the structured normalization enforces schema alignment at the output; and the resulting structured data enables efficient rendering and caching, all of which combine to improve speed, accuracy, and robustness.

In some embodiments, the server uses alternative generative AI models with different architectures, such as encoder-decoder transformers or recurrent neural networks, provided that they accept prompt sentences and output token sequences. The server may apply domain-specific fine-tuning, where the model is trained on a curated dataset of question-answer pairs relevant to a particular product field. During fine-tuning, the server applies a loss function such as cross-entropy on target answer tokens, and updates model weights using gradient-based optimization with learning rate scheduling and regularization. The server may perform data augmentation by paraphrasing questions, adding noise to tokens, or including synthetic follow-up questions, thereby improving the model's robustness to variations in user utterances.

In other embodiments, the server deploys a local generative model on-premises and uses a remote model only as a fallback when confidence metrics fall below a threshold. The server can compute internal confidence scores by analyzing log probabilities of generated tokens or by evaluating the overlap between generated tokens and domain-specific vocabularies. The server can then decide whether to accept the generated text or to request regeneration with different decoding parameters such as lower temperature or constrained beam search. This adaptive decoding procedure further reduces the likelihood of structurally invalid output and enhances computational efficiency.

In another variant, the server employs different structured formats for different applications. For instance, for multi-part answers, the structured format may include fields such as “title”, “summary”, and “detail”, and the response generation unit may use hierarchical parsing rules to map paragraphs into those fields. For troubleshooting scenarios, the structured format may include fields such as “step_number” and “instruction_text”, enabling the terminal to present step-by-step procedures with clear order.

Through these embodiments, the server provides a concrete technical solution that improves the way a computer system integrates speech recognition and generative AI models. The system enhances the internal functioning of computers by optimizing data formats, enforcing structural constraints, and implementing specialized algorithms for prompt construction and response normalization. These features go beyond generic data acquisition and display; they reshape internal data flows and control logic to achieve measurable improvements in processing speed, error rate, and resource utilization.

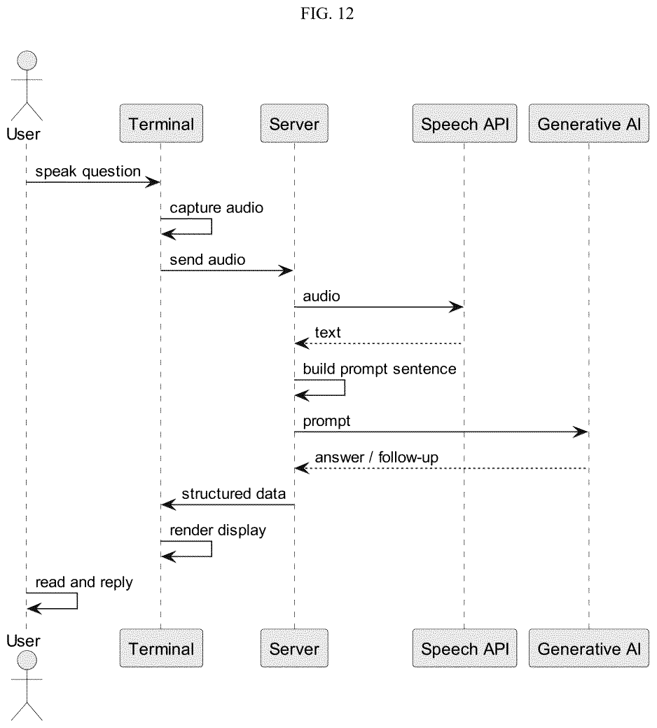

The following describes the processing flow using FIG. 12.

### Step 1:

The user speaks a question.
The user produces analog voice sound, such as asking, “How long is the warranty period for this product?”. The output of this step is an acoustic sound wave in the environment.

### Step 2:

The terminal captures the user's voice and converts it to digital audio.
The terminal uses a built-in microphone and an audio recording API of the operating system to sample the analog sound wave at a predefined sampling rate (for example, 16 kHz) and bit depth (for example, 16-bit linear PCM).
Input: acoustic sound wave from the user.
Processing: the terminal samples the waveform, quantizes amplitude values into integers, and buffers consecutive samples into audio frames stored in memory.
Output: a digital audio signal represented as a sequence of sample values (for example, an array of 16-bit integers).

### Step 3:

The terminal sends the digital audio signal to the server.
The terminal encapsulates the digital audio signal into a request message, for example an HTTP POST body, and adds metadata such as sampling rate, audio encoding type, language code, and session identifier.
Input: the digital audio signal and recording metadata.
Processing: the terminal serializes the audio data into a binary or encoded format, attaches headers, and establishes a secure connection (for example, HTTPS) to the server.
Output: a network packet stream carrying the audio and metadata to the server.

### Step 4:

The server receives and validates the audio data.
The server accepts the incoming HTTP request at an application endpoint, reads the request body, and extracts the audio payload and associated metadata.
Input: the network packet stream from the terminal.
Processing: the server reassembles packets, parses protocol headers, checks content type and length, and verifies that the audio encoding and sampling rate match expected parameters.
The server converts the audio to a standard internal format (for example, 16 kHz mono linear PCM) if necessary, using an audio conversion library.
Output: a validated and normalized digital audio signal stored in server memory.

### Step 5:

The server converts the digital audio into character information using a speech recognition resource.
The server prepares a request to an external speech recognition service by including the normalized digital audio and configuration options such as language, punctuation, and recognition mode.
Input: the normalized digital audio signal.
Processing: the server transmits the audio to the speech recognition resource, which computes acoustic features (for example, Mel-frequency cepstral coefficients), applies a trained neural network acoustic model and a language model, and decodes the most probable text sequence. The server receives the recognition result as structured text data.
Output: character information representing the recognized user utterance, for example the string “How long is the warranty period for this product?”.

### Step 6:

The server selects a prompt template based on the recognized text and context.
The server analyzes the character information and, optionally, session context to determine which template to use for the generation processing instruction sentence.
Input: the recognized character information and context metadata (for example, conversation state, domain tag).
Processing: the server applies rule-based logic or a lightweight classifier to choose among multiple stored templates, such as a template for “answer only” or a template for “answer plus follow-up question”. The server retrieves the selected template from a template repository.
Output: a chosen prompt template containing fixed instruction text and placeholders like {question}.

### Step 7:

The server constructs a concrete prompt sentence for the generative AI model.
The server inserts the recognized question text and constraint information into the selected template to form a complete instruction sentence.
Input: the chosen prompt template and the character information, plus any constraint information such as response style (“polite”, “short”) or domain rules.
Processing: the server performs string substitution, replacing placeholders (for example, {question}, {constraints}) with actual text values. The server concatenates instruction sections and context sections into a single prompt sentence.
Output: a generation processing instruction sentence (prompt sentence), such as:
“You are an in-store customer service assistant. Read the customer's question and generate an accurate and concise answer.\n\nCustomer's question: \“How long is the warranty period for this product?\”\n\nAnswer:”

### Step 8:

The server tokenizes the prompt sentence and sends it to the generative AI model.
The server prepares input for a transformer-based generative AI model by converting the prompt sentence into tokens according to a predefined tokenizer.
Input: the prompt sentence constructed in Step 7.
Processing: the server applies a tokenization algorithm, such as byte pair encoding or sentence piece, to map the text into a sequence of token IDs. The server then creates a model request containing the token sequence and generation parameters (for example, max tokens, temperature, top-p) and transmits this request to the generative AI model endpoint.
Output: a model invocation containing tokenized prompt data sent to the generative AI model.

### Step 9:

The server receives the generated text from the generative AI model.
The server obtains an output token sequence that represents the model's generated response.
Input: the model invocation from Step 8.
Processing: the generative AI model embeds tokens into vectors, processes them through multiple self-attention layers and feed-forward layers, computes probability distributions over the vocabulary at each position, and samples or selects tokens according to the specified decoding strategy. The server receives the resulting token sequence and decodes it back into a text string.
Output: generated text that may contain an answer and optionally a follow-up question, for example: “The warranty period for this product is one year. Would you like to know what is covered under this warranty?”

### Step 10:

The server checks whether the generated text conforms to a predetermined structured format.
The server causes a response generation unit to validate the structure of the generated text against expected patterns.
Input: the generated text from the generative AI model.
Processing: the server applies deterministic parsing rules, such as regular expressions or delimiter detection, to identify sections labeled “Answer:” and “Follow-up:” or to separate sentences by punctuation. The server verifies that the required components (for example, at least one answer sentence) are present and correctly ordered.
Output: a determination result indicating whether the generated text matches the structured format, and parsed components if the format is valid.

### Step 11:

The server normalizes the generated text into structured information.
When the generated text does not fully conform to the structured format, the server transforms it into a standardized key-value structure.
Input: the generated text and the validation result from Step 10.
Processing: the server reorders sentences, assigns the first sentence to an “answer” field and remaining sentences to a “follow_up_question” field, and, if necessary, interpolates default values (for example, an empty follow-up question) when missing. The server constructs a structured data object with explicit fields, such as “answer” and “follow_up_question”.
Output: structured information containing at least an “answer” value and optionally a “follow_up_question” value.

### Step 12:

The server sends the structured information to the terminal.
The server prepares a response message that encapsulates the structured fields for delivery to the terminal.
Input: the structured information from Step 11.
Processing: the server serializes the structured fields into a transport format, attaches status codes and headers, and transmits the message over a secure network connection to the terminal.
Output: a network response containing structured answer and follow-up data delivered to the terminal.

### Step 13:

The terminal parses the structured information and prepares display data.
The terminal application reads the incoming response and extracts the answer and follow-up fields for rendering.
Input: the network response from the server.
Processing: the terminal deserializes the message, maps “answer” to a primary text area and “follow_up_question” to a secondary text area or interactive element, and generates layout parameters such as font size, line breaks, and alignment according to user interface rules.
Output: display data that specifies how text elements should be rendered on the terminal screen.

### Step 14:

The terminal renders the answer and follow-up question on the display.
The terminal uses its display control unit to present the generated information to the user.
Input: the display data constructed in Step 13.
Processing: the terminal's graphics subsystem draws the answer text in a main region of the screen and, when present, draws the follow-up question as a separate line or button. The terminal may also store the rendered state in a local cache for quick re-draw.
Output: a visible screen showing the AI-generated answer and any follow-up question.

### Step 15:

The user reads the displayed information and responds to the customer.
The user observes the answer and optional follow-up question on the terminal display and uses this information for real-world interaction.
Input: the visible screen content rendered by the terminal.
Processing: the user understands the textual information and decides how to communicate it to the customer.
Output: a spoken or otherwise conveyed response to the customer, such as, “The warranty period for this product is one year,” optionally followed by the suggested follow-up question.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional customer-support and dialogue-assistance systems that rely on generative artificial intelligence models typically require a user to shift visual attention to a display, manually read suggested answers, and then convert those answers into spoken responses. Such systems often operate as generic chat interfaces or web applications in which a user must repeatedly look down at a screen, interpret text, and then resume face-to-face interaction. As a result, these systems interrupt the natural flow of conversation, increase cognitive load, and degrade the overall responsiveness and quality of real-time interactions.

Furthermore, existing systems generally treat speech recognition, natural language understanding, generative response creation, and speech synthesis as loosely coupled components. They do not tightly integrate these components in a way that guarantees low-latency, context-aware, and emotion-sensitive audio guidance to a user who remains continuously engaged in a live dialogue. For example, many systems simply pass raw transcribed text to a generative model without encoding dialogue context or emotional cues into a structured prompt sentence, leading to responses that are generic, mismatched in tone, or poorly adapted to the current conversational state.

Additionally, conventional architectures often do not use the emotional characteristics contained in the input audio signal to dynamically shape the prompt for the generative AI model or to control the prosodic properties of synthesized speech. As a consequence, the generated response may be technically correct but emotionally inappropriate (e.g., cheerful tone in a complaint scenario, or overly neutral tone in a situation requiring empathy), which can reduce user trust and effectiveness of human-AI collaboration in customer service and similar domains.

There is therefore a need for an improved computer-implemented system that: (i) transforms incoming audio information into structured text and rich prompt sentences optimized for a generative AI model; (ii) uses emotional analysis of the audio signal to adapt both the content and style of the generated response; (iii) coordinates input, processing, and audio output so that AI guidance is delivered to a user through a wearable listening device without interrupting an ongoing dialogue; and (iv) thereby improves the functioning of the underlying computing system by reducing interaction latency, lowering user cognitive burden, and generating contextually and emotionally aligned audio responses.

The specific processing by the specific processing unit 290 of the data processing device 12 in Example 2 is realized by the following means.

The present invention provides a server comprising a processor configured to receive audio information from a user via an audio input unit, convert the received audio information into text information, generate a prompt sentence based on the text information and a dialogue context, input the prompt sentence into a generative information processing model to cause the generative information processing model to generate response information and additional question information, output the response information and the additional question information as display information via a display unit, convert at least the response information into audio information via a speech synthesis unit, analyze an emotional state of the user or a dialogue counterpart from the audio information, modify the prompt sentence and adjust a content or an acoustic expression of the response information based on a result of the emotional analysis, output the audio information through an audio output unit including a wearable listening device, and control the audio input unit, the display unit, the speech synthesis unit, and the audio output unit such that the response information is provided to the user without interrupting a dialogue between the user and the counterpart. This enables the computing system to more efficiently process audio-based interactions, to generate context-aware and emotion-aligned prompt sentences for the generative AI model, to deliver low-latency synthesized speech directly to the user while maintaining continuous engagement in a live conversation, and thereby to improve the overall performance and usability of computer-implemented conversational assistance.

The term “processor” refers to one or more hardware computation units, such as a central processing unit, a graphics processing unit, or any other processing circuitry, that executes instructions to perform the functions described in the present specification.

The term “audio information” refers to data representing sound, including but not limited to spoken utterances by a user or a dialogue counterpart, which may be captured as analog signals and digitized into audio data.

The term “audio input unit” refers to any hardware or software component configured to acquire audio information from an environment, including a microphone, a microphone array, or an input interface that receives audio data from such devices.

The term “text information” refers to data in a symbolic or character-based representation obtained by converting audio information or other input data into a sequence of characters or tokens interpretable by a natural language processing system.

The term “dialogue context” refers to information related to an ongoing interaction, including at least one of previous utterances, prior system responses, conversation history, user metadata, task parameters, or environmental conditions, which is used to condition generation of responses.

The term “prompt sentence” refers to a structured natural language or token sequence that encodes at least part of the text information and the dialogue context and is provided as input to a generative information processing model to condition generation of output data.

The term “generative information processing model” refers to a machine-learned model that, when provided with an input such as a prompt sentence, generates new information including at least one of natural language text, instructions, or other structured data, and may comprise a neural network or similar parametric model.

The term “response information” refers to information generated by the generative information processing model in reply to the prompt sentence, including at least an answer, explanation, or guidance intended to be presented to a user.

The term “additional question information” refers to information generated by the generative information processing model that proposes one or more follow-up questions or clarifying inquiries to further advance or refine the dialogue.

The term “display information” refers to data in a form suitable for presentation on a visual output device, including text, symbols, icons, or other graphical elements derived from the response information or the additional question information.

The term “display unit” refers to any hardware or software component configured to visually present display information, including a screen, a head-mounted display, or an output interface driving such devices.

The term “speech synthesis unit” refers to hardware, software, or a combination thereof configured to convert text information, including response information, into audio information by performing text-to-speech processing.

The term “audio output unit” refers to any hardware or software component configured to output audio information to a listener, including one or more loudspeakers, earphones, headsets, or interfaces that deliver audio data to such devices.

The term “wearable listening device” refers to an audio output apparatus configured to be worn on or near a user's body, including earphones, headphones, headsets, or similar devices that provide audio information directly to the user.

The term “emotional state” refers to a condition associated with affective attributes of a user or a dialogue counterpart, including but not limited to neutrality, happiness, anger, sadness, or stress, inferred from audio information or other input signals.

The term “acoustic expression” refers to prosodic and auditory characteristics of synthesized or recorded speech, including pitch, intonation, timing, loudness, and speaking style, which influence perceived emotional tone or emphasis.

The term “control” refers to the act performed by the processor of managing operation of components including the audio input unit, the display unit, the speech synthesis unit, and the audio output unit, by issuing commands, scheduling processes, or adjusting parameters so as to achieve specified system behavior, including provision of response information without interrupting a dialogue.

In one or more embodiments, a server implements the claimed system by executing machine-readable instructions on one or more processors such as a central processing unit and, optionally, a graphics processing unit or tensor processing unit. The server is connected via a communication network to at least one terminal operated by a user. The terminal includes an audio input unit, a display unit, a speech synthesis unit, and an audio output unit including a wearable listening device, such as earphones or a headset.

The server uses a memory subsystem to store program modules, dialogue data, acoustic features, prompt sentences, and outputs of a generative AI model. The server executes an operating system, a web application framework, and one or more client libraries for accessing a remote or local generative AI model. In one embodiment, the server uses a natural language processing framework and a deep learning framework to implement a generative AI model in the form of a transformer-based neural network. The server configures the neural network with multiple self-attention layers, feed-forward layers, learned token embeddings, and positional encodings. The server stores trained parameters, including weight matrices for attention heads, layer normalization parameters, and output projection matrices, in a non-transitory memory.

The terminal captures audio information from the user by using the audio input unit. In one embodiment, the terminal uses a microphone array and an analog-to-digital converter to generate digital audio signals. The terminal executes a local speech recognition engine or transmits the captured audio signals to the server for speech recognition. When the terminal executes speech recognition locally, the terminal uses an acoustic model and a language model implemented by a recurrent neural network or a transformer-based network. The terminal converts the audio waveform into a sequence of feature vectors, such as Mel-frequency cepstral coefficients or log-Mel spectrograms, and then decodes the most probable sequence of text tokens according to a beam search algorithm constrained by a language model. The resulting sequence of tokens is assembled into text information that represents the user's utterance.

The server receives the text information and associates it with a dialogue context stored in a structured data format, such as a list or queue of prior utterances and system responses. The server uses a data structure that contains, for each turn, a speaker identifier, a timestamp, a text string, and one or more context labels such as topic or sentiment label. The server updates this data structure by appending the newly received text information.

The server generates a prompt sentence by combining the current text information with at least part of the dialogue context. The server uses a prompt-construction module that applies predefined rules to format the prompt sentence. In one example, the server uses the following template:
“You are an AI assistant supporting a store clerk during face-to-face customer service.
Answer the following customer question clearly and concisely in 2 or 3 sentences.
Question: “[current user question]”
Context: “[summary of last system answer or key dialogue points]””

The server replaces the placeholder “[current user question]” with the latest text information and replaces the placeholder “[summary of last system answer or key dialogue points]” with a compressed representation of previous turns, obtained, for example, by selecting key sentences or by using a separate summarization model. The server thus generates a prompt sentence that encodes not only the latest question but also a compact representation of the dialogue context, resulting in a more specific and constrained input to the generative AI model.

The server analyzes emotional characteristics of the audio information. In one embodiment, the terminal extracts acoustic features such as pitch contour, energy, spectral tilt, and speaking rate from the captured audio. The terminal transmits these features or a compressed representation thereof to the server. The server applies an emotion classification model, such as a neural network trained on labeled emotion corpora, to map the acoustic features and, optionally, the text information to an emotional state label such as “neutral,” “angry,” “sad,” or “excited.” The server stores the emotional state label in association with the current dialogue turn. The server modifies the prompt sentence by adding explicit instructions based on the emotional state. For example, when the emotional state is “angry,” the server may generate a prompt sentence such as:
“You are an AI assistant supporting a store clerk during face-to-face customer service.
The customer appears frustrated or angry; respond in a calm, empathetic, and concise manner.
Answer the following customer question clearly and in 2 or 3 sentences.
Question: “[current user question]””

By inserting emotion-specific constraints directly into the prompt sentence, the server configures the generative AI model to generate responses adapted to the detected emotional state, rather than leaving emotional adaptation to manual control by the user.

The server uses the generative AI model to produce response information and additional question information. The server tokenizes the prompt sentence into a sequence of tokens according to a predefined vocabulary. The server feeds this sequence of tokens into the transformer-based generative AI model, which applies multi-head self-attention to compute contextualized representations of each token. The server then applies feed-forward layers and normalization layers according to the model architecture. The server iteratively predicts next tokens conditioned on the previously generated tokens and the internal hidden states of the model, using a probability distribution over the token vocabulary. The server may apply techniques such as top-k sampling or nucleus sampling to control diversity. The server stops token generation when an end-of-sequence token appears or when a token limit is reached.

The server decodes the generated tokens back into a text string, which becomes the response information. When the model is configured to generate both an answer and one or more follow-up questions, the server parses the output according to predefined delimiters or tags to separate the answer portion (response information) from the follow-up portion (additional question information).

The server adjusts the response information based on the emotional state and other system-level policies. The server may use text post-processing rules that enforce maximum length, remove potentially inappropriate expressions, or simplify overly technical phrasing. The server may further refine the response by applying a secondary classifier or re-ranking step to select from multiple candidate outputs. As a result, the server produces a response that is not only semantically appropriate but also computationally constrained to meet latency and clarity requirements.

The terminal receives the response information and the additional question information from the server via the communication network. The terminal stores them in an internal data structure associated with the current conversation. The terminal outputs the response information and the additional question information on the display unit as text, enabling the user to verify or refer to the generated content. In parallel, the terminal uses the speech synthesis unit to convert at least the response information into audio information.

The terminal implements the speech synthesis unit by using a text-to-speech engine that performs text normalization, phoneme conversion, prosody generation, and waveform synthesis. In one embodiment, the terminal uses a neural text-to-speech architecture such as an encoder-decoder with attention or a neural vocoder. The terminal adjusts prosodic parameters such as pitch range, speaking rate, and energy based on the emotional state determined by the server. For example, if the emotional state is “sad,” the terminal lowers the average pitch and reduces speaking rate to convey empathy. The terminal thus maps the emotional state into acoustic expression parameters, resulting in a synthesized voice that is aligned with the emotional context.

The terminal outputs the synthesized audio information through the audio output unit, including the wearable listening device. The user receives the AI-generated answer as audio while maintaining visual attention on a human dialogue counterpart. The user does not need to read or manually interpret on-screen text, which significantly reduces cognitive shift and interaction latency. The system thereby enables the user to seamlessly integrate AI-generated guidance into natural conversation.

The server improves computer-implemented dialogue assistance by optimizing internal data flows and model interactions in a way that is distinct from a human simply reading and responding. The server performs structured prompt construction that transforms unstructured text information and dialogue context into a standardized prompt sentence format. This reduces ambiguity for the generative AI model and leads to fewer misinterpretations. The server also integrates emotion analysis into the model input and output control, which allows the system to automatically select content and acoustic patterns that match interaction conditions without manual tuning. This integration reduces the number of required round-trips and corrections, thereby lowering network traffic and computational load.

The server configures the generative AI model using a training procedure that further contributes to technical improvements. During training, the server uses a large corpus of dialogue examples annotated with emotional labels and response quality metrics. The server defines a loss function that combines a standard language modeling loss with an auxiliary loss that penalizes responses inconsistent with the target emotional label. The server updates the model weights by gradient-based optimization, such as stochastic gradient descent with adaptive learning rate adjustment. The server may apply data augmentation methods, such as paraphrasing or back-translation, to increase diversity of training examples without increasing manual annotation costs. As a result, the generative AI model learns to condition its output not only on textual content but also on encoded emotional signals, thereby improving robustness and accuracy of emotionally aligned responses.

The server structures the dialogue context by using specialized data fields that record temporal order and emotional state of each turn. The server uses this structured context when constructing prompt sentences, imposing non-standard rules such as limiting context length based on recency or prioritizing emotionally significant turns. These rules differ from a simple chronological concatenation of messages and are designed to reduce prompt size while preserving salient information. This leads to reduced token counts, lower inference latency, and less memory usage in the generative AI model, thereby improving system performance.

The terminal cooperates with the server to reduce processing load and latency. In some embodiments, the terminal performs on-device pre-processing, such as audio feature extraction, noise suppression, and partial speech recognition, before transmitting compact feature representations to the server. By offloading part of the signal processing to the terminal and using compressed representations instead of raw audio streams, the system reduces network bandwidth usage and improves responsiveness, particularly in environments with limited connectivity.

The user operates the terminal in various application scenarios, such as retail customer service, technical support, or medical triage assistance. In each case, the user remains engaged in a real-world task while the system continuously collects audio information, performs emotion-aware analysis, generates prompt sentences, controls a generative AI model, and outputs adapted audio responses. The system's effect is not limited to automating a known human practice but instead modifies the way computing resources are orchestrated for real-time conversational assistance. The server defines specialized data structures for prompt sentences, emotional state metadata, and dialogue context, while the terminal controls audio capture and output pathways in conjunction with these data structures. This combined design reduces delays, minimizes user distraction, and increases overall reliability of interactive AI guidance.

In alternative embodiments, the server uses different architectures for the generative AI model, such as encoder-decoder transformers or mixtures of experts, but continues to implement the same concept of constructing prompt sentences that embed text information, dialogue context, and emotional state instructions. In yet another embodiment, the emotion classification is performed jointly with text generation by a multi-task neural network, which outputs both next-token probabilities and emotion labels. In such a configuration, the server refines the learned emotional representations and reuses them across multiple modules, improving computational efficiency and consistency of behavior.

In some embodiments, the terminal incorporates additional sensors, such as cameras or physiological sensors, and transmits supplemental features to the server. The server augments the dialogue context with these features and incorporates them into prompt sentences as additional conditions. By expanding the feature space beyond speech alone, the system enhances accuracy of emotional and situational assessment and further improves the technical performance of the response generation pipeline.

Through these various embodiments, the server, the terminal, and the user interact with a computing infrastructure that is specifically arranged to construct and use prompt sentences for a generative AI model, to integrate emotion-aware processing, and to control hardware components for speech capture and playback. The system thereby achieves technical effects including reduced latency, improved response accuracy, enhanced emotional appropriateness, lower network bandwidth consumption, and more efficient utilization of computational resources, surpassing a mere automation of human conversational behavior.

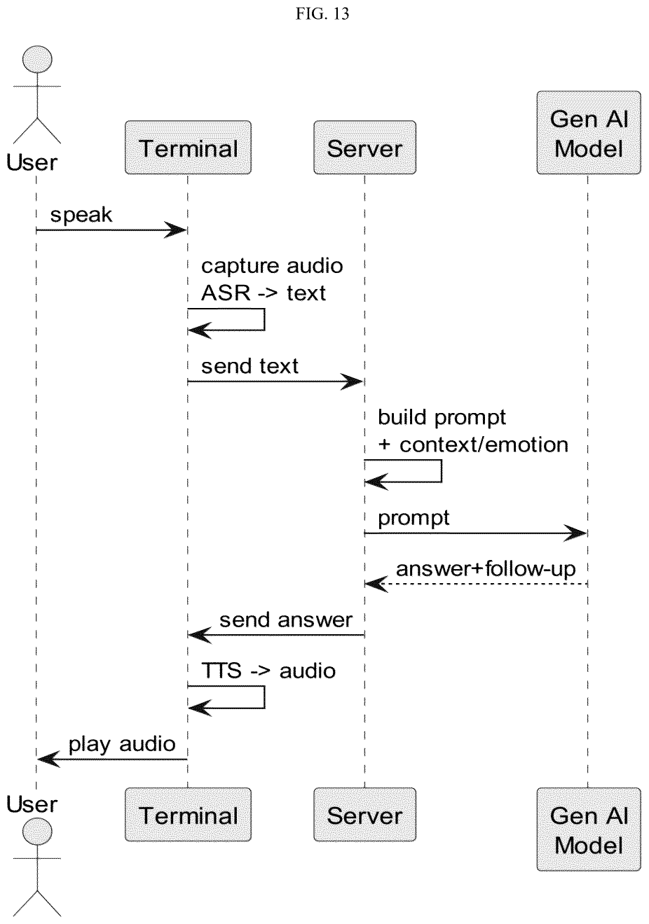

The following describes the processing flow using FIG. 13.

### Step 1:

The user produces audio information representing a natural spoken utterance.
The user speaks a question or statement, for example: “Please tell me the main features of this product,” while facing a customer or another person.
The user's voice is emitted as an analog sound wave, which constitutes the input of this step.
The output of this step is the physical acoustic signal in the environment that is ready to be captured by the terminal.

### Step 2:

The terminal acquires the audio information from the environment through an audio input unit.
The terminal uses a microphone or microphone array to convert the analog sound wave into a digital audio signal by applying analog-to-digital conversion at a defined sampling rate and bit depth.
The input of this step is the acoustic signal produced by the user in Step 1, and the output is a digital audio stream stored in a buffer in the terminal's memory.
The terminal may apply basic preprocessing such as automatic gain control, noise suppression, and echo cancellation on the digital audio stream to improve signal quality.

### Step 3:

The terminal converts the digital audio stream into text information.
The terminal applies a speech recognition algorithm, which takes the digital audio stream as input and computes acoustic features such as Mel-frequency cepstral coefficients or log-Mel spectrograms. The terminal feeds these feature vectors into a trained acoustic model, for example a recurrent neural network or transformer-based network, and uses a language model to decode the most probable sequence of words by performing beam search or similar decoding.
The input of this step is the preprocessed digital audio stream from Step 2, and the output is a sequence of text tokens concatenated into a text string representing the user's utterance.
The terminal stores this text string as the current question or statement in volatile memory and may display it on the screen for confirmation.

### Step 4:

The terminal transmits the text information and, optionally, auxiliary audio features to the server.
The terminal constructs a request message including the recognized text string, a conversation identifier, and optionally compressed acoustic feature vectors that reflect prosodic characteristics of the original speech. The terminal uses a communication library to send this request via a network interface using a predefined protocol.
The input of this step is the text string and feature data from Step 3, and the output is a network message delivered to the server containing structured text and feature data.
The terminal records a timestamp or sequence number so that the server can reconstruct dialogue order.

### Step 5:

The server receives and validates the text information and auxiliary data.
The server parses the incoming network message, extracts the text string, conversation identifier, and any auxiliary audio features, and stores them in a dialogue data structure. The server checks that the text length is within allowable bounds, that the data format is correct, and that the content does not violate predefined system rules.
The input of this step is the network message from Step 4, and the output is validated and stored text information and auxiliary data associated with a current dialogue context.
The server updates or creates a dialogue record in a database or in-memory store keyed by the conversation identifier.

### Step 6:

The server analyzes an emotional state based on audio-derived features and/or text information.
The server uses the auxiliary audio features and the text string as inputs to an emotion classification model, such as a neural network trained to map acoustic and lexical features to emotion labels. The server computes an emotional state label (for example, “neutral,” “angry,” or “excited”) and a confidence score.
The input of this step is the feature set and text from Step 5, and the output is an emotional state label and associated metadata stored in the dialogue record.
The server may apply thresholding on the confidence score and may default to a neutral label when confidence is below a defined value.

### Step 7:

The server assembles a dialogue context representation.
The server accesses prior turns stored in the dialogue record, including previous user utterances, system responses, and associated emotional states. The server selects a subset of the most recent or most relevant turns and compresses them into a context summary by applying rule-based selection or a summarization algorithm.
The input of this step is the stored dialogue history and the new text information and emotional state from Steps 5 and 6, and the output is a structured context object containing ordered text segments, speaker roles, timestamps, and high-level labels.
The server maintains this context object in memory as an input element for prompt construction.

### Step 8:

The server generates a prompt sentence for a generative AI model.
The server uses the current text information and the dialogue context representation to fill predefined template fields. For example, the server may generate a prompt such as:
“You are an AI assistant supporting a store clerk during face-to-face customer service.
The customer appears frustrated or angry; respond in a calm, empathetic, and concise manner.
Answer the following customer question clearly and in 2 or 3 sentences.
Question: “[current user question]”
Context: “[summary of last system answer or key dialogue points]””
The input of this step is the current question text, the emotional state label, and the context object from Steps 6 and 7, and the output is a complete prompt sentence string that encodes task instructions, emotional constraints, and contextual information.
The server stores this prompt sentence in a buffer for subsequent model inference.

### Step 9:

The server prepares model input data and invokes the generative AI model.
The server tokenizes the prompt sentence using a tokenizer associated with the generative AI model's vocabulary, converting the text into a sequence of integer token identifiers. The server organizes these tokens into a model input structure, including token sequences, attention masks, and any special control tokens.
The input of this step is the prompt sentence string from Step 8, and the output is a set of tensors or structured arrays representing tokenized input suitable for the generative AI model.
The server calls a model inference engine, either locally or via a remote model service, and passes the prepared input together with generation parameters such as maximum output length, temperature, and sampling strategy.

### Step 10:

The server causes the generative AI model to generate response information and additional question information.
The server, through the inference engine, processes the tokenized prompt with a transformer-based architecture that computes contextual embeddings for each token using multi-head self-attention, applies feed-forward layers, and iteratively predicts new tokens. The server decodes the sequence of generated tokens into natural language text.
The input of this step is the tokenized prompt and generation parameters from Step 9, and the output is a text string that may include both an answer segment and one or more follow-up question segments.
The server may include markers or apply parsing rules to separate the answer portion (response information) from the follow-up portion (additional question information).

### Step 11:

The server performs post-processing and emotion-aware adjustment of the generated texts.
The server analyzes the raw generated string, removes extraneous characters, enforces length constraints, and applies text normalization. The server may adjust phrasing based on the emotional state, for example by softening expressions when the emotional state indicates anger or stress.
The input of this step is the raw generated text from Step 10 and the emotional state label from Step 6, and the output is cleaned and adjusted response information and additional question information.
The server stores these adjusted texts in the dialogue record and prepares a response payload for transmission to the terminal.

### Step 12:

The server transmits the response information and additional question information to the terminal.
The server encapsulates the adjusted texts in a structured network message, adds metadata such as identifiers and timestamps, and sends this message to the terminal via the communication network.
The input of this step is the adjusted response information and additional question information from Step 11, and the output is a network response received by the terminal containing text data ready for display and audio conversion.
The server may log the transaction for monitoring and system improvement.

### Step 13:

The terminal receives the generated texts and prepares them for display and speech synthesis.
The terminal parses the network response, extracts the response information and the additional question information, and stores them in local memory associated with the current conversation. The terminal may format the texts for on-screen display, such as splitting them into paragraphs or highlighting key terms.
The input of this step is the server's network response from Step 12, and the output is structured text objects residing in the terminal's memory, suitable for both visual output and text-to-speech conversion.
The terminal updates its user interface components to reflect the new information.

### Step 14:

The terminal converts the response information into audio information via a speech synthesis unit.
The terminal sends the response text to a text-to-speech engine that performs text normalization, phoneme sequence generation, prosody modeling, and waveform synthesis.
The terminal may supply emotional or style parameters derived from the emotional state so that the synthesized voice matches the desired tone.
The input of this step is the response text object from Step 13 and, optionally, emotional parameters, and the output is a synthesized digital audio signal representing spoken version of the response.
The terminal buffers this audio signal in preparation for playback.

### Step 15:

The terminal outputs the synthesized audio through the audio output unit to the user.
The terminal uses an audio playback subsystem to send the synthesized digital audio signal to the wearable listening device via a wired or wireless connection. The terminal controls playback timing so that the audio is presented promptly after generation.
The input of this step is the buffered synthesized audio from Step 14, and the output is audible speech perceived by the user through the wearable listening device.
The terminal may simultaneously maintain or update the display content so that the user can optionally reference the text visually.

### Step 16:

The user listens to the AI-generated audio response and integrates it into an ongoing dialogue.
The user perceives the synthesized speech and uses the content of the response to formulate an immediate spoken reply to a dialogue counterpart, such as a customer, without having to divert gaze to the terminal display.
The input of this step is the auditory output provided by the terminal in Step 15, and the output is a human-spoken reply and an updated conversational state in the real-world interaction.
The user may then produce a new question or clarification, which returns the flow to Step 1 for another cycle of processing using the generative AI model and prompt sentence construction.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional voice-based assistance systems that utilize natural language processing and machine learning often treat speech recognition, language understanding, response generation, and audio output as loosely coupled components. In many implementations, audio input is simply transcribed and passed as plain text to a generic response engine, without maintaining structured session context or exploiting detailed conversational state. As a result, such systems can exhibit high latency, inconsistent response quality, and limited ability to adapt responses to user-specific context over multiple turns.

Furthermore, known systems typically provide only a direct mapping from a recognized utterance to a response. They do not systematically generate and manage a structured prompt sentence for a generative AI model based on both question semantics and accumulated conversation history. This lack of structured prompt generation degrades the effectiveness of the generative AI model, because the model is not consistently guided with explicit, machine-constructed context, roles, and objectives. Consequently, response relevance, coherence, and controllability remain suboptimal from a computing standpoint.

In addition, while some systems include separate emotion analysis modules, they generally do not integrate emotion information into the core control loop of prompt construction and response generation. Emotion information, when present, is often used only to select from a fixed set of templates or to apply superficial style changes at the user interface layer. This disjointed use of emotion analysis prevents the computing pipeline from dynamically adjusting generative AI behavior and synthesized audio characteristics in a systematic, machine-controlled manner.

From a computer technology perspective, there is therefore a need for an improved processing architecture that: (i) acquires and manages audio data together with robust session identification and conversation history; (ii) performs multi-stage analysis including speech recognition and advanced natural language processing to derive compact question summary information as structured data; (iii) automatically constructs machine-generated prompt information, including a prompt sentence, tailored to a generative AI model; and (iv) tightly integrates emotion analysis results into both the prompt information and the subsequent response adjustment pipeline. Without such an integrated design, computing resources are not efficiently used, the generative AI model is not effectively guided, and the resulting responses cannot be optimized for accuracy, latency, and emotional appropriateness in real time.

Accordingly, an object of the present invention is to improve computer functionality in voice-interactive systems by providing a processor-controlled architecture that: manages audio and text data with explicit session context; automatically generates structured prompt information for a generative AI model based on question summary information and conversation history; and utilizes emotion information both to control the prompt sentence and to adjust the generated response text and synthesized audio. This yields technical benefits such as more accurate and context-aware responses, reduced manual prompt engineering, more efficient use of networked AI resources, and improved robustness and responsiveness of the overall computing system.

The specific processing by the specific processing unit 290 of the data processing device 12 in Application Example 2 is realized by the following means.

The present invention provides a server comprising a processor configured to receive audio data from an audio acquisition device to obtain voice information from a user, store the audio data as digital signals in a temporary storage area while assigning session identification information to the audio data, perform speech recognition processing on the audio data to generate character string data, execute natural language processing including syntactic analysis processing and semantic analysis processing on the character string data to extract question summary information that summarizes question content, generate prompt information including a prompt sentence to be input to a generative artificial intelligence model based on the question summary information and conversation history information, input the prompt information to the generative artificial intelligence model to obtain generated text information including a response sentence and an additional question sentence, format the generated text information into a predetermined output format and store the generated text information as the conversation history information, generate a speech-synthesis script based on the generated text information, input the speech-synthesis script to a speech-synthesis processing unit to generate synthesized audio data, and transmit the synthesized audio data to an audio output device while outputting the generated text information to a display device, the processor being further configured to execute emotion analysis processing on the audio data or the character string data to obtain emotion information and include the emotion information in the prompt information so as to control the prompt sentence for the generative artificial intelligence model in accordance with an emotion state, and to execute response adjustment processing to modify wording of the generated text information based on the emotion information and generate the speech-synthesis script from the modified generated text information so as to generate synthesized audio data adjusted in accordance with the emotion state. This enables the computing system to automatically construct and manage structured prompt sentences tailored to a generative AI model based on session-aware question summary information and emotion information, to generate and adjust response text and synthesized audio under centralized processor control, and thereby to improve technical performance characteristics of the voice-interactive system, including response relevance, robustness across multi-turn dialogs, and adaptive audio output behavior.

The term “audio acquisition device” refers to a hardware or software component configured to capture sound waves and convert the sound waves into digital audio data for processing by the system.

The term “audio data” refers to information representing sound in a digital form, including sampled and quantized signals that encode user speech for storage, transmission, and analysis.

The term “voice information” refers to semantic and acoustic content conveyed by user speech, including spoken words, phrases, and prosodic features that can be derived from audio data.

The term “temporary storage area” refers to a memory region or storage resource used to hold data, such as audio data or intermediate processing results, for a limited duration during execution of system operations.

The term “session identification information” refers to data that uniquely associates audio data and related processing results with a particular interaction instance, user, or conversation, thereby enabling session-level state management.

The term “speech recognition processing” refers to computational operations that convert audio data containing speech into corresponding text data, typically using acoustic and language models.

The term “character string data” refers to a sequence of characters representing recognized text obtained from speech recognition processing, suitable for further linguistic or semantic analysis.

The term “natural language processing” refers to a series of computational techniques applied to text, including syntactic analysis and semantic analysis, to derive linguistic structure, meaning, and intent from the text.

The term “syntactic analysis processing” refers to operations that determine grammatical structure of text, including part-of-speech tagging, parsing, and identification of syntactic relationships between words or phrases.

The term “semantic analysis processing” refers to operations that derive meaning from text, including identification of intents, entities, and relationships that reflect the user's underlying question or command.

The term “question summary information” refers to structured data that concisely describes essential content of a user's question, extracted from character string data by natural language processing.

The term “conversation history information” refers to stored data representing past interactions in a session, including previous questions, responses, and system-generated text used as context for subsequent processing.

The term “prompt information” refers to data constructed by the processor that includes at least one prompt sentence and optional contextual metadata, intended as input to a generative artificial intelligence model.

The term “prompt sentence” refers to a text sequence that instructs a generative artificial intelligence model regarding task, context, role, constraints, or desired output style for generating a response.

The term “generative artificial intelligence model” refers to a computational model configured to generate natural language text in response to input prompt information, using machine learning techniques such as deep learning.

The term “generated text information” refers to one or more text sequences output by the generative artificial intelligence model, including at least a response sentence and optionally an additional question sentence.

The term “response sentence” refers to a text portion of the generated text information that provides an answer or explanation corresponding to the user's question or request.

The term “additional question sentence” refers to a text portion of the generated text information that poses a follow-up question or clarification request to continue or refine the interaction.

The term “predetermined output format” refers to a structured representation of generated text information, defined in advance, that specifies arrangement, segmentation, or tagging for storage or output handling.

The term “speech-synthesis script” refers to a text-based representation prepared for input to a speech-synthesis processing unit, optionally including markup or control codes for prosody, pauses, or emphasis.

The term “speech-synthesis processing unit” refers to a hardware or software component configured to convert a speech-synthesis script into synthesized audio data representing artificial speech.

The term “synthesized audio data” refers to digital audio signals generated by the speech-synthesis processing unit that represent machine-produced speech corresponding to input text.

The term “audio output device” refers to a component such as a speaker or earphone configured to convert synthesized audio data into audible sound for a user.

The term “display device” refers to a component such as a monitor, screen, or panel configured to present generated text information visually to a user.

The term “emotion analysis processing” refers to computational operations that infer emotional states from audio data or character string data, using analysis of acoustic features or linguistic cues.

The term “emotion information” refers to data representing a detected or inferred emotional state, such as anxiety, calmness, satisfaction, or frustration, along with optional confidence values or scores.

The term “emotion state” refers to a classification or characterization of a user's emotional condition at a given time, derived from emotion analysis processing.

The term “response adjustment processing” refers to computational operations that modify wording, structure, or style of generated text information based on auxiliary data, such as emotion information, while preserving core semantic content.

In one embodiment, a server cooperates with at least one terminal to provide real-time, voice-based assistance to a user. The user may be, for example, a clerk interacting with a customer in a physical store. The server includes a processor, a volatile memory, a non-volatile storage device, and one or more network interfaces. The terminal includes an audio acquisition device such as a microphone, an audio output device such as an earphone or speaker, an optional display device, and a communication interface capable of connecting to the server over a packet-switched network.

The terminal acquires acoustic signals from the user via the microphone. The terminal converts the analog acoustic signals into digital audio data using an analog-to-digital converter and stores the digital audio data in a local buffer. The terminal encapsulates the buffered audio data into network packets, attaches metadata such as a device identifier, a timestamp, and a language code, and transmits the packets to the server through a secure communication protocol such as Transport Layer Security over Hypertext Transfer Protocol.

The server receives the network packets via the network interface and reconstructs the audio data stream. The server stores the reconstructed audio data as digital samples in a temporary storage area of the memory or the storage device. The server assigns session identification information to the audio data. The session identification information may be a unique identifier that associates the audio data with a particular interaction session, user, or terminal.
The server uses the session identification information to index conversation history information and to link multiple user utterances within the same dialog.

The server uses a speech recognition component to convert the audio data into character string data. The speech recognition component may be implemented by calling an external speech recognition service, such as a cloud-based speech-to-text application programming interface, or by executing an on-premises automatic speech recognition engine. In one example, the server passes the audio data, along with parameters such as sampling rate, audio encoding format, and language code, to a speech recognition engine that uses a deep neural network-based acoustic model and a statistical language model to produce a time-aligned sequence of recognized words. The speech recognition component outputs character string data representing the user's utterance and optionally outputs word-level confidence scores and timestamps.

The server executes natural language processing on the character string data. The server uses a natural language processing library or a custom module to perform tokenization, part-of-speech tagging, syntactic parsing, and semantic role labeling. The server applies dependency parsing to identify the main predicate, subjects, objects, and modifiers in the character string data. The server identifies entities such as product names, time expressions, and quantities using named entity recognition. Based on syntactic and semantic analysis, the server derives question summary information. The question summary information is stored as a structured record, for example including fields such as an intent label, a list of entities, and a normalized representation of the question.

The server stores the character string data and the question summary information in association with the session identification information as part of the conversation history information. The conversation history information may be maintained as a sequence of records, where each record contains the recognized user utterance, the corresponding system response, and associated metadata such as timestamps and emotion information. The server uses a data structure such as a key-value store, a document database, or an in-memory list indexed by the session identification information to manage the conversation history.

The server performs emotion analysis processing on at least one of the audio data and the character string data. For audio-based emotion analysis, the server extracts acoustic features from the audio data, such as pitch contour, energy envelope, spectral centroid, formant frequencies, and speaking rate. The server feeds these features into a trained neural network classifier, which may be a convolutional neural network or a recurrent neural network with long short-term memory units, to output probabilities for emotion classes such as “anxious,” “calm,” “angry,” or “confident.” For text-based emotion analysis, the server applies a model that analyzes word choice, syntax, and sentence structure to compute emotion scores. The server may combine the audio-based and text-based emotion scores using a weighted averaging rule or a learned fusion model to obtain final emotion information. The emotion information includes an emotion state label and confidence values.

The server constructs prompt information for a generative AI model based on the question summary information, the conversation history information, and the emotion information.

The server generates a prompt sentence that specifies a role for the generative AI model, a description of the user's question, the detected emotion state, and specific instructions for generating an answer and an additional question. The server may also append relevant prior turns from the conversation history information to provide context for multi-turn dialog. The server structures the prompt information as a sequence of text segments, such as a system instruction part, a context part, and a user question part.

In one example, the server constructs the following prompt sentence as the system instruction and user question:
“System: You are a generative AI model assisting a retail store clerk in real time.
Context: The clerk is wearing an earphone and cannot show the answer directly to the customer. The response must be short, clear, and easy to repeat aloud.
Customer question: ‘How long is the warranty for this product?’
Customer emotion: anxious.
Instruction:
1. Provide a concise answer about the warranty period and what is covered.
2. Add one short follow-up question that reassures the customer and offers further help.
3. Do not mention that you are an AI or reference the system architecture.”

The server inputs the prompt information, including the prompt sentence, to a generative AI model. In one embodiment, the generative AI model is implemented as a large-scale transformer-based neural network with an encoder-decoder or decoder-only architecture. The generative AI model is pre-trained on large corpora of text using language modeling objectives and then optionally fine-tuned on dialog data. The server transmits the prompt information to the generative AI model over an application programming interface. The server may specify parameters such as sampling temperature, maximum number of output tokens, and penalization factors for repetition.

The generative AI model processes the prompt information by applying multi-head self-attention layers and feed-forward layers to compute contextualized representations for each token in the prompt information. The model computes probability distributions over a vocabulary for successive output tokens and generates output text in an auto-regressive manner. The server receives generated text information including at least one response sentence and one additional question sentence. For example, the generative AI model may output:
“The warranty for this product is one year. During that period, repairs for manufacturing defects are provided at no additional cost. Would you like me to explain what types of issues are covered under the warranty?”

The server analyzes the generated text information and may segment it into sub-parts corresponding to the response sentence and the additional question sentence. The server checks the generated text information for length constraints, prohibited content, and formatting requirements. The server may apply rule-based filters to remove extraneous phrases or to enforce specific politeness levels. The server then formats the generated text information into a predetermined output format, which may include fields such as “answer_text,” “follow_up_text,” and “emotion_tag,” and stores the formatted information in the conversation history information associated with the session identification information.

The server uses the emotion information to perform response adjustment processing. The server applies deterministic rules or an additional neural rewriter model to modify the wording of the generated text information. For example, if the emotion information indicates that the user is anxious, the server may prepend reassurance phrases, simplify technical terms, and lengthen certain explanations within specified bounds. The server may maintain a table of transformation patterns mapped to emotion states, and it may apply these patterns to the generated text information without changing the underlying factual content. The server thus generates modified generated text information that reflects both the original answer content and the emotion-aware adjustments.

The server generates a speech-synthesis script based on the modified generated text information. The speech-synthesis script may include markup such as speech synthesis markup language tags to specify pauses, emphasis, and prosodic variations. The server structures the script so that the main answer and the additional question are spoken with appropriate pacing and intonation. The server then inputs the speech-synthesis script into a speech-synthesis processing unit. The speech-synthesis processing unit may be a neural text-to-speech engine with an encoder that converts text into phoneme or grapheme sequences, a prosody predictor, and a waveform generator such as a neural vocoder. The unit outputs synthesized audio data that represents artificial speech.

The server transmits the synthesized audio data to the terminal via the network interface. The server may stream the audio data in chunks to reduce perceived latency so that the terminal can begin playback before the entire audio sequence is transferred. The server also sends the generated text information or the modified generated text information to the terminal for potential display on a screen. The server updates the conversation history information to mark the completion of the response and to prepare for the next user utterance.

The terminal receives the synthesized audio data and buffers it in local memory. The terminal drives the audio output device, such as an earphone or speaker, to convert the synthesized audio data into audible sound. The user hears the answer and the additional question through the audio output device while maintaining direct interaction with the customer. The terminal may optionally display the text of the answer and the additional question on a display device for the user to read or confirm.

The user listens to the synthesized audio and then verbally communicates the substance of the answer and any follow-up question to the customer. When the customer asks a further question, the user again speaks into the microphone of the terminal, and the above-described operations are repeated with the new audio data. The server uses the conversation history information, including previous questions and answers, when constructing subsequent prompt information so that the generative AI model can produce contextually consistent responses across multiple turns.

In another embodiment, the server executes all or part of the speech recognition and emotion analysis locally, while the generative AI model is executed on a separate computing platform. In yet another embodiment, the terminal executes on-device speech recognition and sends character string data instead of audio data to the server, thereby reducing network bandwidth usage. In such a case, the server still performs natural language processing, prompt construction, generative AI invocation, response adjustment, and speech synthesis.

The server improves computer technology by introducing a structured processing pipeline that explicitly separates audio acquisition, speech recognition, natural language understanding, prompt construction, generative response generation, emotion-aware adjustment, and speech synthesis. The server uses specific data structures such as session identification information and conversation history information to manage dialog state across multiple turns. By automatically generating machine-constructed prompt sentences that incorporate question summary information and emotion information, the server reduces reliance on static or manually authored prompts and enables more consistent and controllable use of a generative AI model. This structured prompt generation reduces the number of tokens needed to convey essential context, improving throughput and reducing network and computation costs.

The server further improves response accuracy and stability by fusing emotion analysis into the prompt construction and response adjustment pipelines, rather than treating emotion only as a superficial display property. Because the server derives emotion information from both acoustic and textual features using trained neural classifiers, and then deterministically applies transformation rules to adjust wording and prosody, the overall system can reduce misinterpretations in emotionally sensitive contexts and improve user satisfaction. These effects are realized through specific internal data flows, feature computations, neural network inferences, and rule-based transformations executed under program control, and are not achievable by mere human mental processes.

During model training, a training system (which may be co-located with or separate from the server) constructs training datasets from transcribed dialog logs, annotated with intents, entities, and emotion labels. The training system trains the generative AI model using gradient-based optimization and a loss function that may combine language modeling loss and dialog response quality metrics. The training system trains the emotion recognition network using a classification loss such as cross-entropy over labeled emotion classes, and may perform data augmentation on audio data, such as time-stretching, pitch-shifting, and noise injection, to improve robustness. The trained weights are then deployed to the server's inference modules. The server updates the model parameters periodically by retrieving new trained versions, thereby improving recognition accuracy, response quality, and emotion detection performance over time.

In summary, the server cooperates with the terminal and the user to implement a voice-interactive system that uses a generative AI model driven by automatically constructed prompt sentences. The system uses specific hardware components (microphones, speakers, displays, network interfaces, processors, and memory) and specific software modules (speech recognition engines, natural language processing libraries, neural emotion classifiers, transformer-based generative models, and neural text-to-speech engines) in a coordinated data processing pipeline. As a result, the system achieves technical effects such as lower end-to-end latency, improved response relevance and emotional appropriateness, more efficient use of computational and network resources through structured prompt construction, and enhanced robustness in multi-turn conversational scenarios.

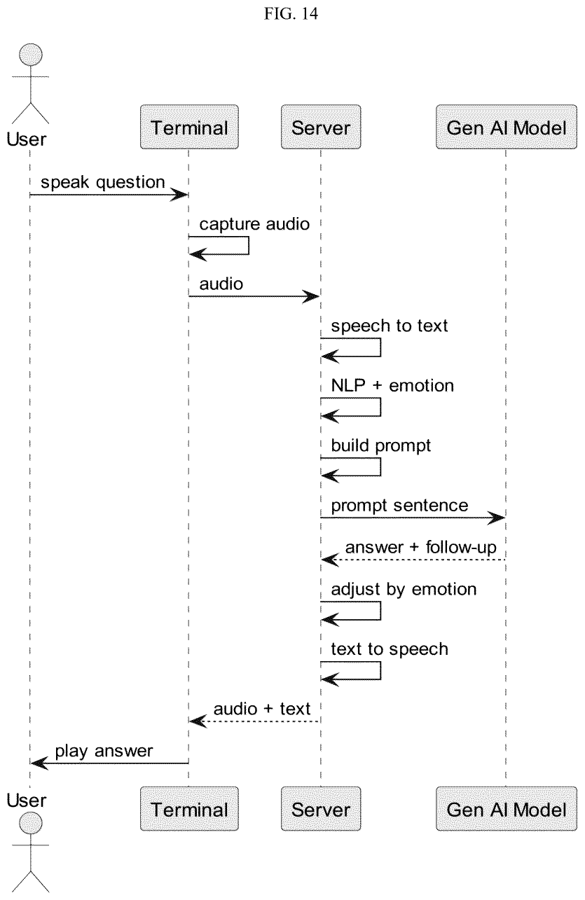

The following describes the processing flow using FIG. 14.

### Step 1:

User speaks a question into the microphone of the terminal.
User provides as input an acoustic signal corresponding to natural speech (for example, “How long is the warranty for this product?”).
User produces continuous audio that the terminal will convert into digital audio data, without manually triggering any button, so that the interaction feels natural and hands-free.

### Step 2:

Terminal captures and digitizes the user's speech.
Terminal receives as input the analog acoustic signal from the microphone and performs analog-to-digital conversion at a predetermined sampling rate and bit depth (for example, 16 kHz, 16-bit mono).
Terminal outputs digital audio data as a sequence of audio frames and stores them in a local buffer. Terminal may apply basic signal processing such as noise suppression or automatic gain control to improve recognition quality, based on the incoming waveform.

### Step 3:

Terminal packages audio data with metadata and transmits it to the server.
Terminal receives as input the buffered digital audio frames and device-specific information such as device identifier, timestamp, and language code.
Terminal performs data encapsulation by assembling the audio frames into network packets, attaching metadata headers (session candidate ID, codec type, language), and encrypting the packets using a secure protocol.
Terminal outputs encrypted audio packets and sends them to the server via a network interface, for example over a secure HTTP or WebSocket connection.

### Step 4:

Server receives the audio packets and reconstructs the audio stream.
Server receives as input the encrypted audio packets from the terminal.
Server performs decryption, verifies integrity of the packets, orders the packets according to sequence numbers, and concatenates the payloads into a continuous audio stream.
Server outputs reconstructed audio data as digital samples and stores the audio data in a temporary storage area in memory or on disk.

### Step 5:

Server assigns session identification information and initializes conversation context.
Server receives as input the reconstructed audio data and any metadata from the terminal, such as a proposed session identifier or user identifier.
Server checks whether a session already exists for the user or terminal; if not, server generates a new session identification value (for example, a random or time-based unique identifier).
Server associates the audio data with the session identification information, initializes or updates a conversation history record in a data structure, and outputs a bound pair of (session ID, audio data) for downstream processing.

### Step 6:

Server performs speech recognition on the audio data.
Server receives as input the audio data and configuration parameters (sampling rate, audio format, language code) linked to the session ID.
Server calls a speech recognition engine, which may be based on a deep neural acoustic model and a language model, to convert the audio signal into text. Internally, the engine extracts acoustic features (for example, Mel-frequency cepstral coefficients), applies a neural network to produce phoneme or subword probabilities, and decodes the probabilities using a language model to obtain likely word sequences.
Server outputs character string data representing the recognized utterance (for example, “How long is the warranty for this product?”) and, optionally, word-level confidence scores and timestamps.

### Step 7:

Server cleans and normalizes the recognized text.
Server receives as input the raw character string data from the speech recognition engine.
Server performs text preprocessing such as trimming whitespace, normalizing punctuation, unifying numeral formats (for example, converting “1 year (in Japanese)” to “1 year”), and removing non-speech markers.
Server outputs cleaned text data that is suitable for reliable natural language processing, and stores this cleaned text in the conversation history associated with the session ID.

### Step 8:

Server executes natural language processing to extract question summary information.
Server receives as input the cleaned text data and the current session context.
Server applies natural language processing steps, including tokenization, part-of-speech tagging, syntactic parsing, and semantic role labeling, using an NLP library or a custom model. The server identifies the main verb, the target object (for example, “warranty”), and any modifiers (for example, “this product”).
Server transforms the linguistic analysis into structured question summary information, such as an intent label (for example, “ask_warranty”), a list of entities (for example, product_reference), and a normalized representation (for example, “query warranty period for current product”).
Server outputs the question summary information and stores it in association with the session ID in the conversation history.

### Step 9:

Server performs emotion analysis based on audio and/or text.
Server receives as input the audio data, the cleaned text data, and the session ID.
Server extracts acoustic features (pitch, energy, spectral features, speaking rate) from the audio data and feeds these features into a trained emotion classifier (for example, a recurrent neural network). Server also applies a text-based emotion model to the cleaned text to evaluate word choice and syntax.
Server combines the outputs of the audio-based classifier and text-based classifier, for example using weighted averaging or a fusion network, to compute final emotion information, including an emotion state label (for example, “anxious”) and confidence scores.
Server outputs the emotion information and stores it in the conversation history linked to the session ID.

### Step 10:

Server constructs prompt information including a prompt sentence for the generative AI model.
Server receives as input the question summary information, the emotion information, the cleaned text data, and the conversation history information associated with the session ID.
Server composes a structured prompt, which may contain a system role description, context description, the most recent user question, the detected emotion state, and explicit instructions for the generative AI model. The server may also include selected previous questions and answers from the conversation history to preserve context.
Server generates a prompt sentence or a block of prompt text such as:
“System: You are a generative AI model assisting a retail store clerk in real time.
Context: The clerk is wearing an earphone and cannot show the answer directly to the customer. The response must be short, clear, and easy to repeat aloud.
Customer question: ‘How long is the warranty for this product?’
Customer emotion: anxious.
Instruction:
1. Provide a concise answer about the warranty period and what is covered.
2. Add one short follow-up question that reassures the customer and offers further help.
3. Do not mention that you are an AI or reference the system architecture.”
Server outputs prompt information, including this prompt sentence, as a text object ready to be sent to the generative AI model.

### Step 11:

Server calls the generative AI model with the prompt information.
Server receives as input the prompt information and parameter settings (for example, maximum token length, temperature).
Server transmits the prompt text to a generative AI model endpoint implemented as a transformer-based neural network. The model internally encodes the prompt tokens, applies multi-head self-attention and feed-forward layers to compute contextual embeddings, and generates output tokens one by one according to learned probability distributions.
Server receives as output generated text information from the model, including at least one response sentence and one additional question sentence. For example, the output may be:
“The warranty for this product is one year. During that period, repairs for manufacturing defects are provided at no additional cost. Would you like me to explain what types of issues are covered under the warranty?”

### Step 12:

Server validates and formats the generated text information.
Server receives as input the raw generated text information from the generative AI model.
Server checks the text for safety and policy constraints, length limits, and required formatting. The server may apply rule-based filters to remove unwanted content or to ensure that the output does not reference internal system details. Server splits the text into logical segments, such as an answer part and a follow-up question part, based on punctuation and heuristic rules.
Server outputs formatted generated text information in a predetermined structure (for example, fields “answer_text” and “follow_up_text”) and updates the conversation history record for the session ID with this information.

### Step 13:

Server adjusts the generated text using the emotion information.
Server receives as input the formatted generated text information and the emotion information for the current utterance.
Server applies response adjustment processing to modify wording according to the emotion state. For example, for an anxious state, the server may insert reassurance phrases (“Please don't worry,” “We will support you throughout the warranty period”) at designated positions, or may simplify complex technical terms using a pre-defined substitution dictionary. These modifications are applied through deterministic rules or a constrained rewriting model while preserving the factual meaning.
Server outputs modified generated text information that reflects emotion-aware adjustments and stores the modified text in the conversation history.

### Step 14:

Server generates a speech-synthesis script from the modified text.
Server receives as input the modified generated text information.
Server composes a speech-synthesis script by concatenating the answer and follow-up question, and, if supported, embedding prosody control tags (for example, specifying pauses, emphasis, or pitch range). The server may choose different prosody patterns depending on the emotion state to produce a soothing or energetic tone.
Server outputs the speech-synthesis script as formatted text suitable for a text-to-speech engine.

### Step 15:

Server performs speech synthesis to create synthesized audio data.
Server receives as input the speech-synthesis script.
Server calls a speech-synthesis processing unit, which may internally tokenize the script into phonemes, predict prosodic features, and generate a speech waveform using a neural vocoder. The unit converts the script into synthesized speech by performing numerical operations such as convolution and up-sampling within the neural network.
Server outputs synthesized audio data (for example, in a compressed audio format) representing the spoken answer and follow-up question and associates this audio data with the session ID.

### Step 16:

Server sends synthesized audio and text to the terminal.
Server receives as input the synthesized audio data and the modified generated text information.
Server packages the audio data and text into a response message, optionally segmenting the audio into streaming chunks to reduce latency. The server includes metadata such as session ID and response identifiers in the message.
Server outputs the response message and transmits it over the network interface to the terminal.

### Step 17:

Terminal receives the response and prepares playback and display.
Terminal receives as input the response message from the server.
Terminal extracts the synthesized audio data and the text fields (answer and follow-up question) from the message. Terminal buffers the audio data in local memory to ensure continuous playback and may load the text into a user interface component for display.
Terminal outputs buffered audio ready for playback and, if available, a prepared text view on a display device.

### Step 18:

Terminal plays the synthesized audio to the user and optionally displays the text.
Terminal receives as input the buffered synthesized audio data and the prepared text view.
Terminal drives the audio output device, converting the digital audio samples into analog signals that produce audible sound. In parallel, the terminal may render the answer and follow-up question as text on a screen so the user can read or confirm the content.
Terminal outputs audible speech to the user and visible text on the display, thereby completing the response delivery.

### Step 19:

User listens to the response and continues the interaction with the customer.
User receives as input the audible response through the earphone or speaker and can, if present, read the text on the display.
User interprets the content and then restates or paraphrases the answer to the customer in natural conversation. If the follow-up question is appropriate, the user may ask it to the customer.
User outputs a spoken reply to the customer and, upon receiving any new question, repeats the process starting from speaking into the terminal microphone, thereby enabling an ongoing, multi-turn dialog with AI-supported responses.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

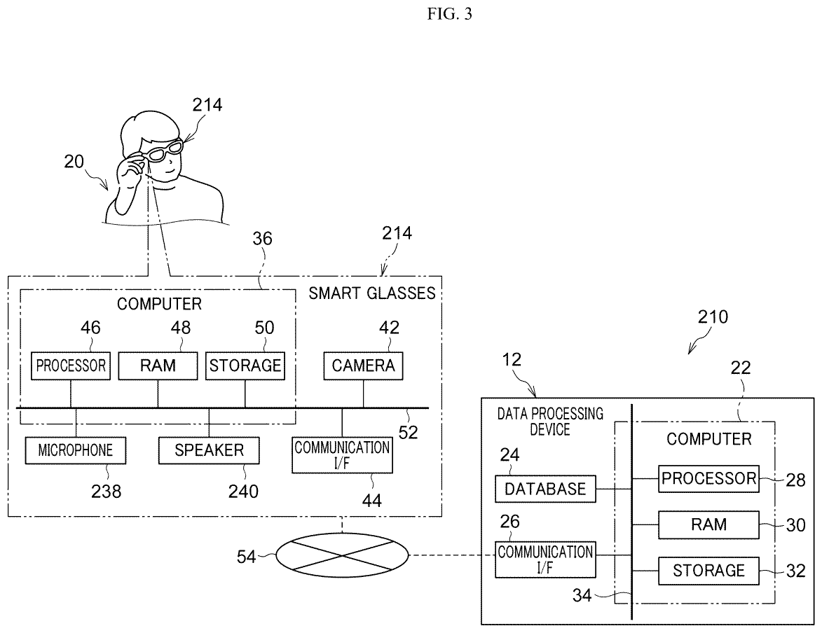

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

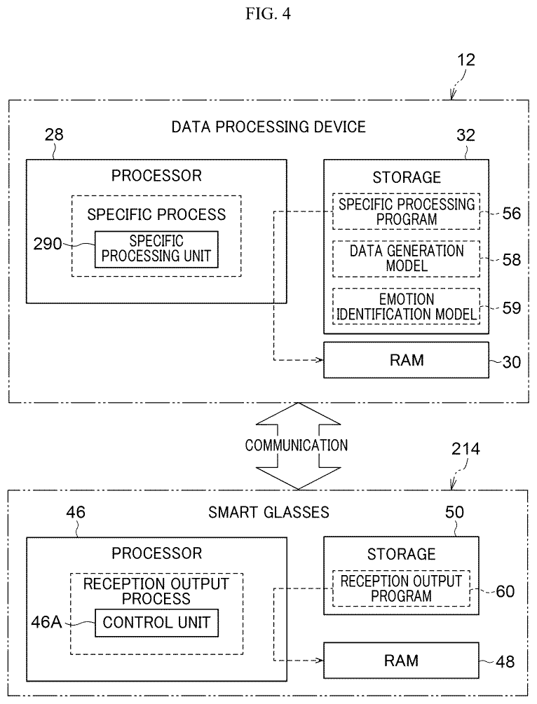

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naëve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

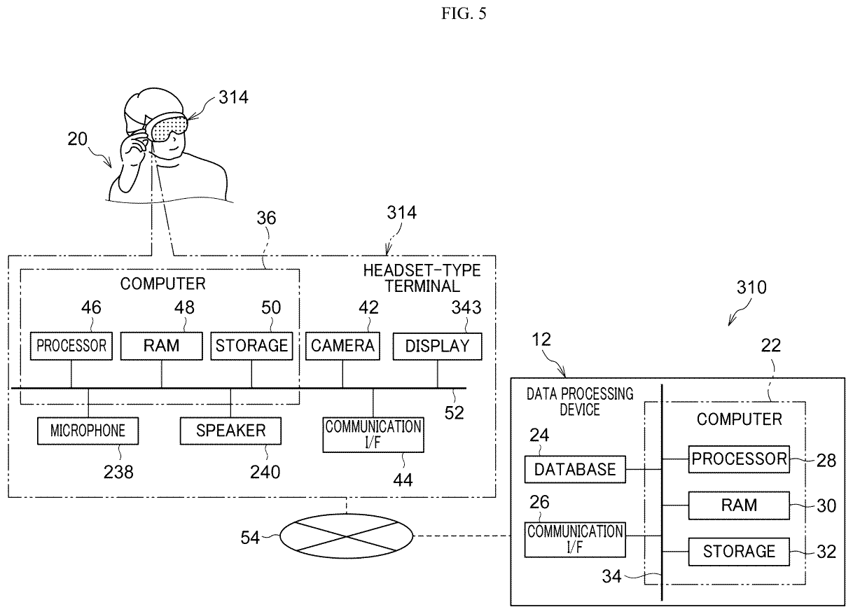

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

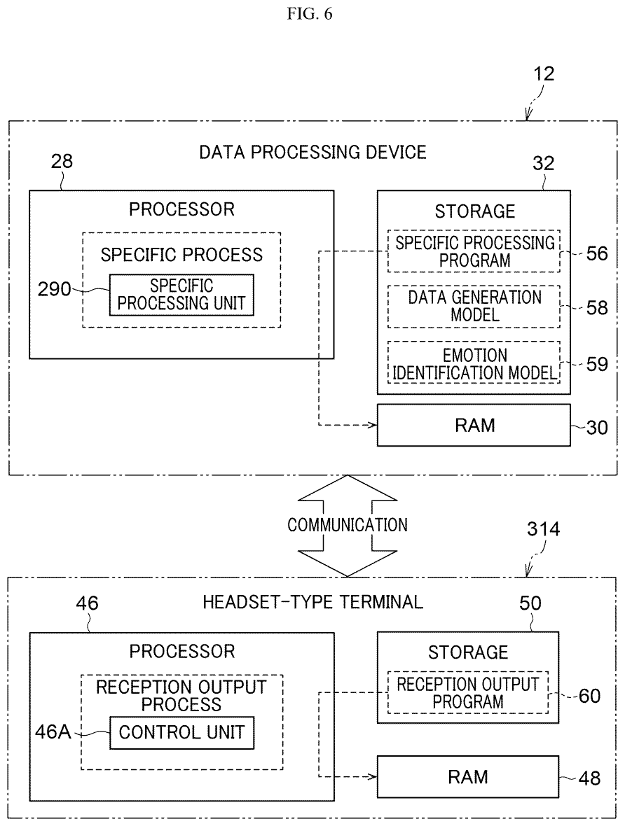

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

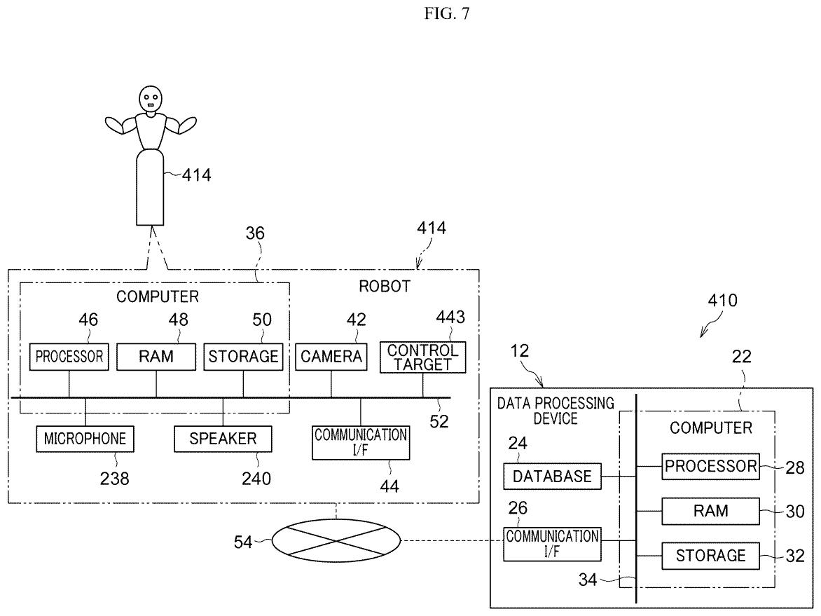

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

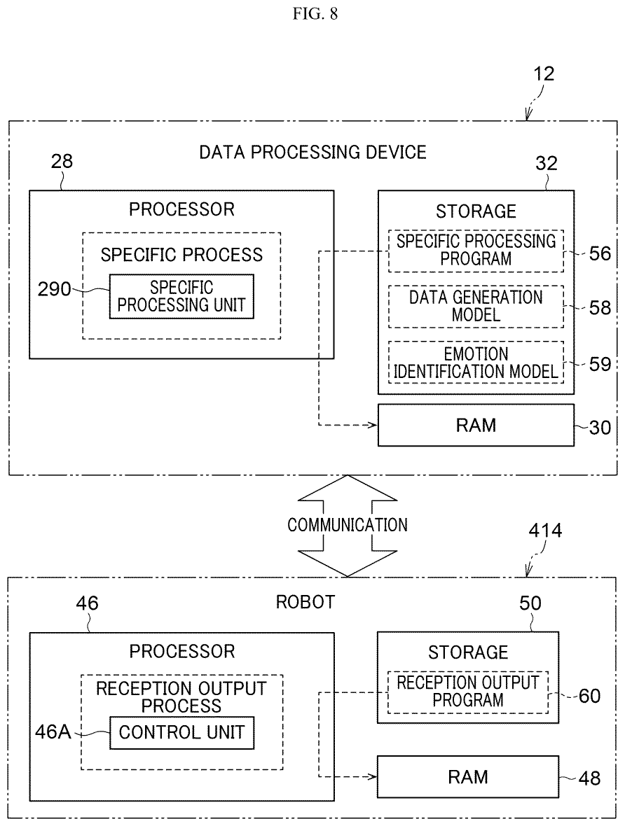

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

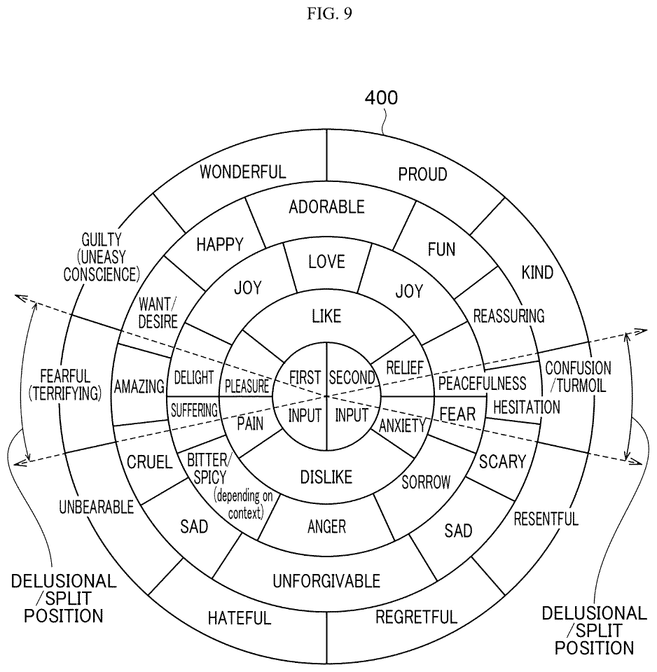

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

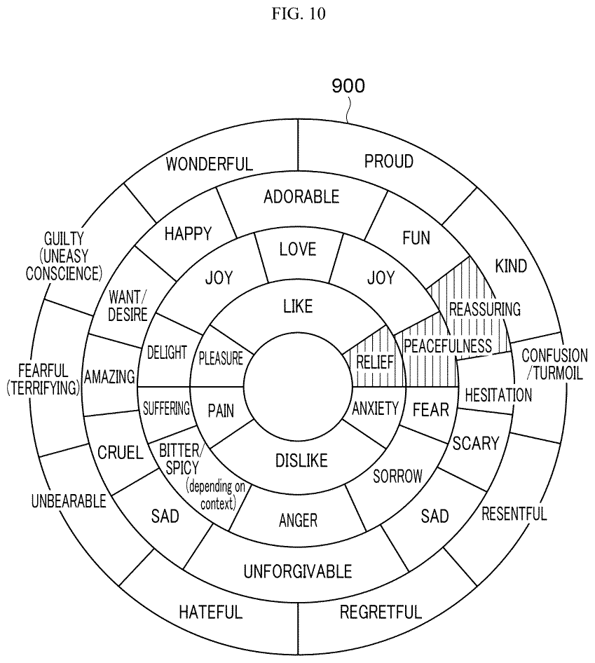

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire audio information from a sound input apparatus and generate digital audio data, obtain the digital audio data and convert the digital audio data into character information using a speech recognition technique,
obtain the character information and extract question content and intent information from the character information using a language analysis technique,
generate a prompt sentence to be input to a generative processing model based on the question content and the intent information, provide the prompt sentence and the character information to the generative processing model, and cause the generative processing model to generate response information and additional input question information,
format the response information and the additional input question information obtained from the generative processing model, and output the formatted response information and the formatted additional input question information as visual information on a display apparatus,
convert the response information and the additional input question information into audio data using a speech synthesis technique and cause an audio output apparatus to output the audio data,
select the prompt sentence from a plurality of templates according to at least one of the question content and the intent information, and dynamically generate the prompt sentence by inserting the character information into a selected template, and
transmit the response information and the additional input question information to a terminal apparatus and cause a display apparatus of the terminal apparatus to display the response information and the additional input question information.

### Supplementary 2

The system according to supplementary 1,
wherein the processor is configured to
perform emotion analysis processing on the character information to extract emotion information, and change content of the prompt sentence based on the emotion information so that the generative processing model generates the response information and the additional input question information according to the emotion information.

### Supplementary 3

The system according to supplementary 1,
wherein the processor is configured to
adjust at least one of expression content of the response information and the additional input question information and a parameter for speech synthesis based on the emotion information, and convert the adjusted response information and the adjusted additional input question information into audio data using the speech synthesis technique and output the audio data.

### Application Example 1

### Supplementary 1

A system comprising a processor,
wherein the processor is configured to
receive, as input data, voice information acquired from a user and convert the voice information into a digital signal in a time domain or a frequency domain by using an audio information acquisition unit, and
convert the digital audio signal acquired by the audio information acquisition unit into character information by using an external information processing resource having a speech recognition function, and construct, on the basis of the character information, a generation processing instruction sentence by a natural language processing unit, and
input the generation processing instruction sentence constructed by the natural language processing unit into an external generative information processing model, and format response sentence information and additional input guidance sentence information acquired from the generative information processing model by a response generation unit, and
transmit, by an information providing unit, the formatted response sentence information and additional input guidance sentence information as structured information to a terminal device and cause the terminal device to convert the structured information into display information capable of being visually presented, and
output, by a display control unit in the terminal device, the display information as a display screen for the user.

### Supplementary 2

The system according to supplementary 1,
wherein the processor is configured to cause the natural language processing unit to select at least one template of a plurality of templates for the generation processing instruction sentence in accordance with a content of the character information, and to construct the generation processing instruction sentence by inserting the character information and response style condition information or business condition information into the selected template.

### Supplementary 3

The system according to supplementary 1,
wherein the processor is configured to cause the response generation unit to determine whether information acquired from the generative information processing model conforms to a predetermined structured format, and, when the information does not conform to the predetermined structured format, to reorder or supplement the information so as to conform to the predetermined structured format before outputting the information to the information providing unit.

### Example 2

### Supplementary 1

A system comprising a processor,
wherein the processor is configured to
receive audio information from a user by using an audio input unit,
analyze the received audio information and convert the audio information into text information,
generate a prompt sentence based on the text information and a dialogue context,
input the prompt sentence into a generative information processing model and cause the generative information processing model to generate response information and additional question information,
output the response information and the additional question information as display information by using a display unit,
convert the response information into audio information by using a speech synthesis unit,
output the audio information generated by the speech synthesis unit to the user through an audio output unit comprising a wearable listening device, and
control the audio input unit, the display unit, the speech synthesis unit, and the audio output unit such that the response information is provided to the user without interrupting a dialogue between the user and a counterpart.

### Supplementary 2

The system according to supplementary 1,
wherein the processor is configured to
analyze an emotional state of the user or the counterpart from the audio information, modify contents of the prompt sentence based on the emotional state, and cause the generative information processing model to generate the response information and the additional question information according to the emotional state.

### Supplementary 3

The system according to supplementary 1,
wherein the processor is configured to
adjust a content or an acoustic expression of the response information based on a result of the analysis of the emotional state, convert the adjusted response information into the audio information by using speech synthesis, and output the audio information through the audio output unit.

### Application Example 2

### Supplementary 1

A system comprising a processor,
wherein the processor is configured to
receive audio data from an audio acquisition device to obtain voice information from a user,
store the audio data as digital signals in a temporary storage area, and assign session identification information to the audio data,
perform speech recognition processing on the audio data to generate character string data, execute natural language processing including syntactic analysis processing and semantic analysis processing on the character string data to extract question summary information that summarizes question content, and generate prompt information including a prompt sentence to be input to a generative artificial intelligence model based on the question summary information and conversation history information,
input the prompt information to the generative artificial intelligence model to obtain generated text information including a response sentence and an additional question sentence, and format the generated text information into a predetermined output format and store the generated text information as the conversation history information, and
generate a speech-synthesis script based on the generated text information, input the speech-synthesis script to a speech-synthesis processing unit to generate synthesized audio data,
transmit the synthesized audio data to an audio output device, and output the generated text information to a display device.

### Supplementary 2

The system according to supplementary 1,
wherein the processor is configured to
execute emotion analysis processing on the audio data or the character string data to obtain emotion information, and include the emotion information in the prompt information so as to control the prompt sentence for the generative artificial intelligence model in accordance with an emotion state.

### Supplementary 3

The system according to supplementary 1,
wherein the processor is configured to
execute response adjustment processing to modify wording of the generated text information based on the emotion information, and generate the speech-synthesis script from the modified generated text information and perform speech-synthesis processing, thereby generating synthesized audio data adjusted in accordance with the emotion state.

What is claimed is:

1. A system comprising:
circuitry configured to:
acquire audio data representing a voice utterance from a user;
perform speech recognition processing on the audio data by applying Mel-frequency cepstral coefficient feature extraction including window function application, fast Fourier transform computation, Mel filter bank filtering, and discrete cosine transform computation to generate acoustic feature vectors, and decoding the acoustic feature vectors using an acoustic model and a statistical language model to generate character information representing a text transcription of the voice utterance;
perform natural language processing on the character information by applying tokenization, part-of-speech tagging, syntactic parsing, and transformer-based intent classification to generate intent information identifying an intent class associated with the voice utterance and question content information identifying a subject of the voice utterance;
generate a prompt sentence by selecting a template from a template store based on the intent information and substituting the question content information into a variable field of the selected template;
perform generative artificial intelligence inference by inputting the prompt sentence to a transformer-based language model and applying autoregressive decoding to generate response information and additional question information; and
perform speech synthesis by inputting the response information to a neural speech synthesizer that generates a spectrogram representation and applies a vocoder to convert the spectrogram representation into an output audio waveform, and output the output audio waveform and the additional question information.

2. The system of claim 1, wherein the circuitry is configured to:
perform emotion analysis on the character information by computing sentence embeddings and applying a neural classifier to the sentence embeddings to generate emotion information identifying an emotion category of the voice utterance; and
select the template from the template store based on both the intent information and the emotion information.

3. The system of claim 2, wherein the circuitry is configured to:
adjust prosodic parameters of the neural speech synthesizer based on the emotion information to modify at least one of speech rate, pitch contour, and energy envelope of the output audio waveform.

4. The system of claim 3, wherein the circuitry is configured to:
apply a confidence threshold to the intent classification output by the transformer-based intent classification; and
in response to a confidence score falling below the confidence threshold, select a fallback template from the template store that generates a clarification request as the prompt sentence.

5. The system of claim 4, wherein the circuitry is configured to:
split the response information and the additional question information from an output sequence generated by the transformer-based language model at a delimiter token; and
transmit a structured payload comprising the response information and the additional question information to a display terminal for visual presentation simultaneously with the output audio waveform.

6. The system of claim 1, wherein the transformer-based intent classification applies multi-head self-attention layers over a token sequence derived from the character information to compute a probability distribution over a plurality of intent classes.

7. The system of claim 6, wherein the plurality of intent classes comprise at least warranty inquiry, price inquiry, and product specification inquiry.

8. The system of claim 1, wherein the acoustic model comprises one of a deep neural network, a time-delay neural network, or a recurrent neural network, and wherein decoding applies one of beam search decoding or Viterbi decoding.

9. The system of claim 1, wherein the template store comprises a rule table mapping combinations of intent classes and emotion categories to respective template identifiers.

10. The system of claim 9, wherein the circuitry is configured to:
perform named entity recognition on the character information to identify entity tokens; and
substitute the entity tokens into one or more additional variable fields of the selected template.

11. The system of claim 1, wherein the transformer-based language model applies an encoder-decoder architecture or a decoder-only architecture, and wherein autoregressive decoding generates output tokens sequentially conditioned on previously generated tokens.

12. The system of claim 11, wherein the circuitry is configured to:
apply beam search decoding during the autoregressive decoding to maintain a plurality of candidate output sequences ranked by cumulative log-probability score.

13. The system of claim 1, wherein the neural speech synthesizer applies a sequence-to-sequence model with attention to map a phoneme sequence derived from the response information to the spectrogram representation.

14. The system of claim 13, wherein the vocoder applies a neural waveform synthesis model to convert the spectrogram representation into the output audio waveform.

15. The system of claim 2, wherein the emotion categories comprise at least neutral, positive, negative, and frustrated.

16. The system of claim 1, wherein the Mel-frequency cepstral coefficient feature extraction applies a sliding window function to frame the audio data into overlapping segments prior to fast Fourier transform computation.

17. The system of claim 1, wherein the circuitry is configured to:
convert an analog audio input signal to the audio data by applying analog-to-digital conversion and buffering the resulting digital audio data.

18. A system comprising:
circuitry configured to:
acquire audio data representing a voice utterance;
apply Mel-frequency cepstral coefficient feature extraction and an acoustic model to the audio data to generate character information;
apply transformer-based intent classification with multi-head self-attention to the character information to generate intent information;
apply emotion analysis using sentence embeddings and a neural classifier to the character information to generate emotion information;
select a template from a template store based on the intent information and the emotion information and substitute question content into the selected template to generate a prompt sentence;
input the prompt sentence to a transformer-based language model and apply autoregressive decoding to generate response information; and
input the response information to a neural speech synthesizer to generate a spectrogram representation, apply a vocoder to generate an output audio waveform, and adjust prosodic parameters of the neural speech synthesizer based on the emotion information.

19. The system of claim 18, wherein the circuitry is configured to apply a confidence threshold to the intent classification and, in response to a confidence score falling below the confidence threshold, select a fallback template from the template store that generates a clarification request as the prompt sentence.

20. A method performed by circuitry, the method comprising:
acquiring audio data representing a voice utterance from a user;
performing speech recognition processing on the audio data by applying Mel-frequency cepstral coefficient feature extraction and decoding using an acoustic model and a statistical language model to generate character information;
performing natural language processing on the character information by applying tokenization and transformer-based intent classification to generate intent information and question content information;
performing emotion analysis on the character information by computing sentence embeddings and applying a neural classifier to generate emotion information;
generating a prompt sentence by selecting a template from a template store based on the intent information and the emotion information and substituting the question content information into the selected template;
performing generative artificial intelligence inference by inputting the prompt sentence to a transformer-based language model and applying autoregressive decoding to generate response information and additional question information; and
performing speech synthesis by inputting the response information to a neural speech synthesizer that generates a spectrogram representation, applying a vocoder to convert the spectrogram representation into an output audio waveform, and adjusting prosodic parameters of the neural speech synthesizer based on the emotion information.
